(19) United States
(12) Patent Application Publication
(10) Pub. No.: US 2019/0069550 A1
(43) Pub. Date: Mar. 7, 2019

(54) HERBICIDAL COMPOSITIONS CONTAINING PYRIDINE CARBOXYLIC ACIDS OR DERIVATIVES THEREOF, WITH PDS AND VLCFA INHIBITORS, OR DERIVATIVES THEREOF

(71) Applicant: Dow AgroSciences LLC, Indianapolis, IN (US)

(72) Inventors: Norbert M. Satchivi, Carmel, IN (US); Bryston L. Bangel, Camby, IN (US)

(73) Assignee: Dow AgroSciences LLC, Indianapolis, IN (US)

(21) Appl. No.: 16/118,485

(22) Filed: Aug. 31, 2018

Related U.S. Application Data
(60) Provisional application No. 62/553,192, filed on Sep. 1, 2017.

(51) Int. Cl. A01N 43/40

(52) U.S. Cl. CPC A01N 43/40; A01N 43/08; A01N 2300/00

(57) ABSTRACT

Disclosed herein are herbicidal compositions containing a herbicidally effective amount of (a) a pyridine carboxylic acid herbicide or an agriculturally acceptable N-oxide, salt, or ester thereof, and (b) a phytoene desaturase (PDS) inhibitor, a very long chain fatty acid (VLCFA) synthesis inhibitor, or a mixture thereof. Also disclosed herein are methods of controlling undesirable vegetation which comprise applying to vegetation or an area adjacent the vegetation or applying to soil or water to prevent the emergence or growth of vegetation (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof, wherein (a) and (b) are each added in an amount sufficient to provide a herbicidal effect.

### CROSS REFERENCE TO RELATED APPLICATIONS

This application claims the benefit of U.S. Provisional Patent Application Ser. No. 62/553,192 filed Sep. 1, 2017, which is expressly incorporated by reference in its entirety herein.

### FIELD OF THE DISCLOSURE

The present disclosure relates to herbicidal compositions containing a herbicidally effective amount of (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof. The present disclosure also relates to methods for controlling undesirable vegetation.

### BACKGROUND

Many recurring problems in agriculture involve controlling growth of undesirable vegetation that can, for instance, inhibit crop growth. To help control undesirable vegetation, researchers have produced a variety of chemicals and chemical formulations effective in controlling such unwanted growth.

However, a continuing need exists for improved compositions and methods to control growth of undesirable vegetation.

### SUMMARY OF THE DISCLOSURE

Disclosed herein are herbicidal compositions containing a herbicidally effective amount of (a) a pyridine carboxylic acid herbicide or an agriculturally acceptable N-oxide, salt, or ester thereof, and (b) a phytoene desaturase (PDS) inhibitor, a very long chain fatty acid (VLCFA) synthesis inhibitor, or mixtures thereof. In some aspects, the weight ratio of (a) to (b) can be from 1:14000 to 4:1 (e.g., from 1:7000 to 1:1, from 1:280 to 2:1, from 1:10 to 3:1, or from 1:5 to 4:1). In some aspects, the activity of the mixtures is greater than the sum of the activity of the individual active ingredients.

The pyridine carboxylic acid herbicide is a compound of Formula (I)

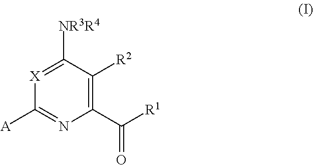

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio; R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

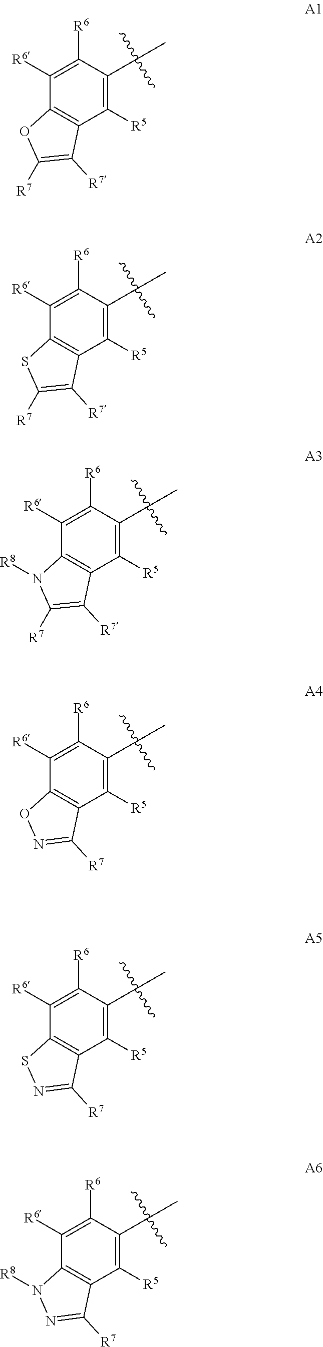

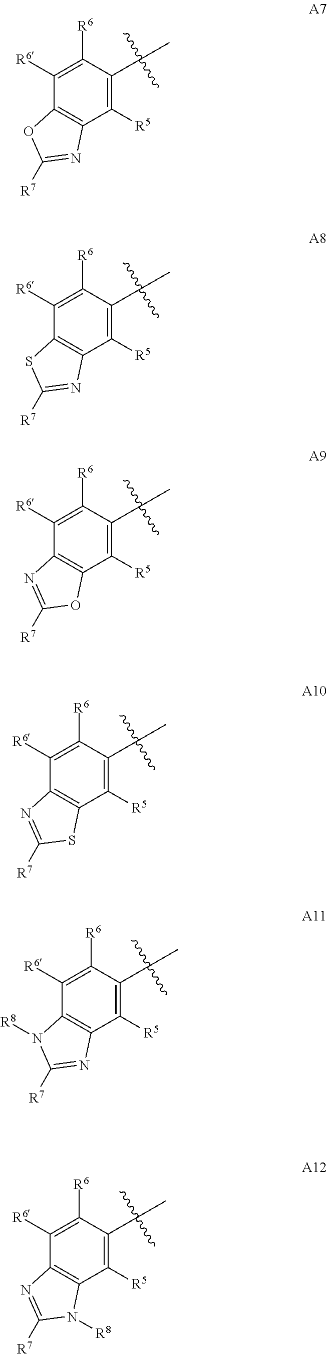

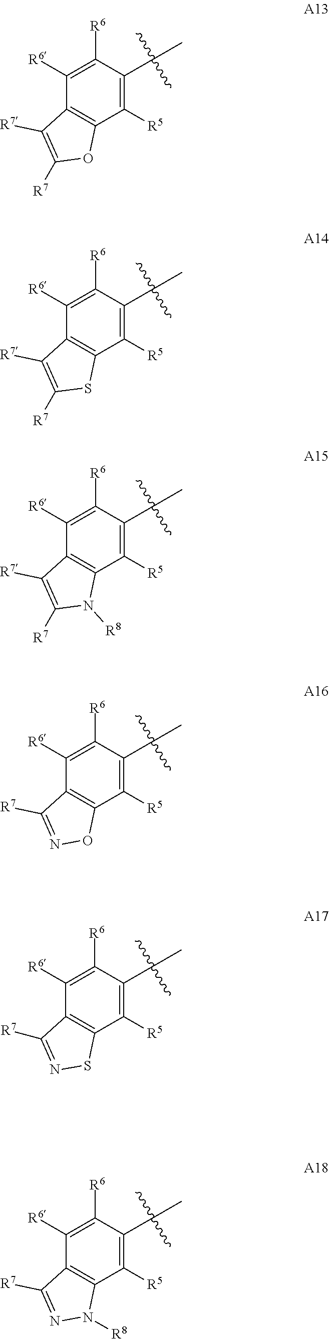

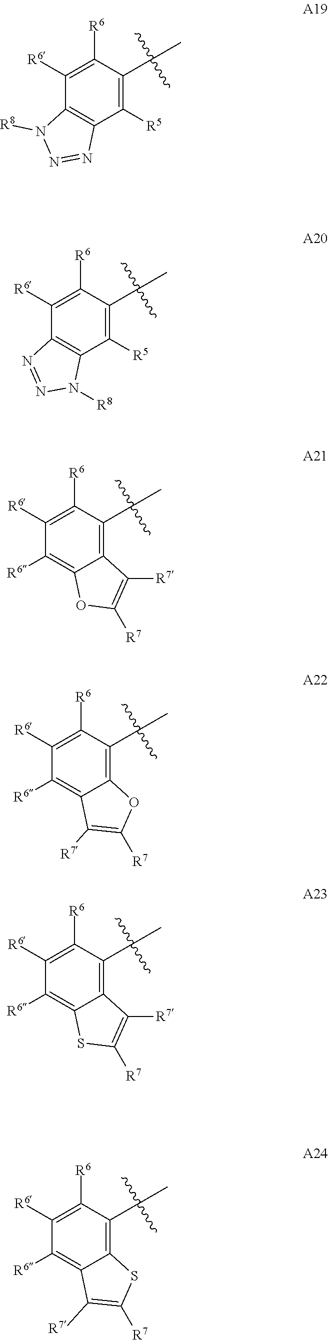

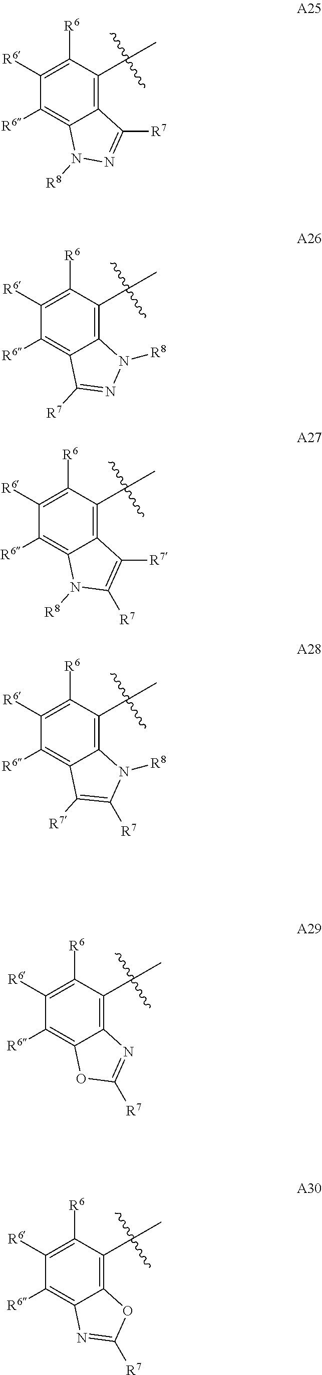

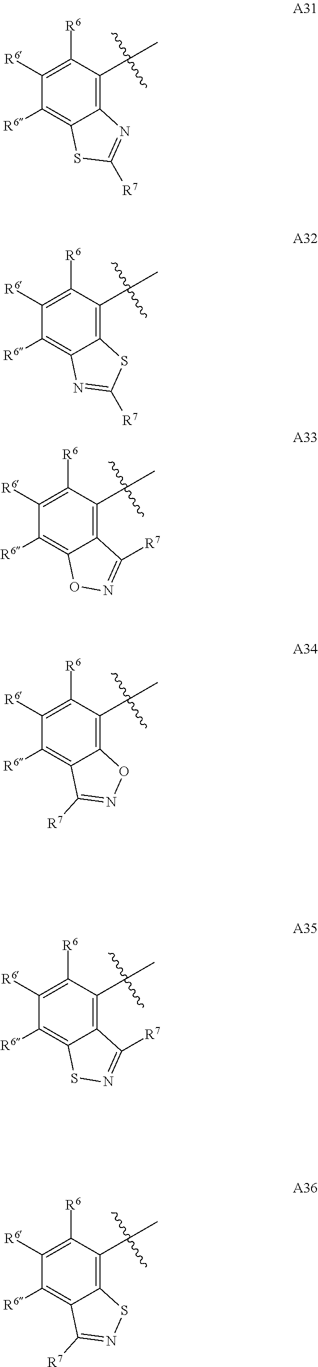

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In certain aspects, the pyridine carboxylic acid herbicide is a compound of Formula (II):

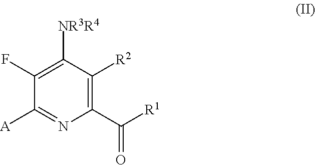

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In some aspects, R¹ is OR^{1′}, wherein R^{1′} is hydrogen, C₁-C₈ alkyl, or C₇-C₁₀ arylalkyl. In certain aspects, R² is Cl, methoxy, vinyl, or 1-propenyl; R³ and R⁴ are hydrogen; A is A15; R⁵ is hydrogen or F; and R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain aspects, the pyridine carboxylic acid herbicide is a compound of Formula (III):

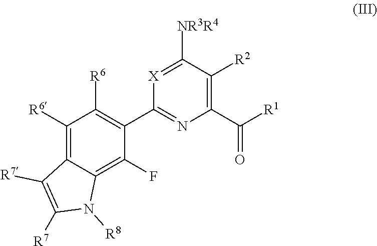

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In some aspects, X is N, CH or CF. In certain aspects, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain aspects, the pyridine carboxylic acid herbicide is 4-amino-3-chloro-5-fluoro-6-(7-fluoro-1H-indol-6-yl) picolinic acid or an agriculturally acceptable N-oxide, salt, or ester thereof.

In some aspects, (b) is a phytoene desaturase (PDS) inhibitor. In certain aspects, (b) is beflubutamid, diflufenican, fluridone, flurochloridone, flurtamone, norflurazon, or picolinafen, or combinations thereof.

In some aspects, (b) is a very long chain fatty acid (VLCFA) synthesis inhibitor. In certain aspects, (b) is acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, or thenylchlor, or combinations thereof.

In some aspects, (b) is a mixture of one or more PDS inhibitor with one or more VLCFA synthesis inhibitor. In certain aspects, (b) is diflufenican plus flurtamone or diflufenican plus flurtamone and flufenacet, or combinations thereof.

The composition can further comprise an additional pesticide, a herbicidal safener, an agriculturally acceptable adjuvant or carrier, or a combination thereof. The composition can be provided as a herbicidal concentrate.

Methods of controlling undesirable vegetation which include applying to vegetation or an area adjacent the vegetation or applying to soil or water to prevent the emergence or growth of vegetation a herbicidally effective amount of (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or mixtures thereof are also described herein. In some aspects, (a) and (b) are applied simultaneously. In still other aspects, (a) and (b) are applied post-emergence of the undesirable vegetation. In some aspects, the activity of the mixtures is greater than the sum of the activity of the individual active ingredients.

In some aspects, (a) is a pyridine carboxylic acid herbicide described above. In certain aspects, (a) is 4-amino-3-chloro-5-fluoro-6-(7-fluoro-1H-indol-6-yl) picolinic acid or an agriculturally acceptable N-oxide, salt, or ester thereof. In some aspects, (b) is a phytoene desaturase (PDS) inhibitor. In certain aspects, (b) is beflubutamid, diflufenican, fluridone, flurochloridone, flurtamone, norflurazon, or picolinafen. In some cases, (a) can be applied in an amount of from 0.5 grams acid equivalent per hectare (g ae/ha) to 50 g ae/ha (e.g., from 5 g ae/ha to 40 g ae/ha) and/or (b) can be applied in an amount of from 12.5 grams active ingredient per hectare (g ai/ha) to 4500 g ai/ha (e.g., from 12.5 g ai/ha to 50 g ai/ha). In some cases, (a) and (b) can be applied in a weight ratio of from 1:9000 to 4:1 (e.g., from 1:1000 to 1:1, from 1:100 to 2:1, from 1:50 to 3:1, or from 1:5 to 4:1).

In some aspects, (a) is a pyridine carboxylic acid herbicide described above. In certain aspects, (a) is 4-amino-3-chloro-5-fluoro-6-(7-fluoro-1H-indol-6-yl) picolinic acid or an agriculturally acceptable N-oxide, salt, or ester thereof. In some aspects, (b) is a very long chain fatty acid (VLCFA) synthesis inhibitor. In certain aspects, (b) is acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, or thenylchlor. In some cases, (a) can be applied in an amount of from 0.5 g ae/ha to 50 g ae/ha (e.g., from 5 g ae/ha to 40 g ae/ha) and/or (b) can be applied in an amount of from 40 g ai/ha to 6720 g ai/ha (e.g., from 10 g ai/ha to 1000 g ai/ha). In some cases, (a) and (b) can be applied in a weight ratio of from 1:14000 to 2:1 (e.g., from 1:7000 to 1:1, from 1:1000 to 1.3:1, from 1:500 to 1.7:1, or from 1:10 to 2:1).

In some aspects, (a) can contain a pyridine carboxylic acid herbicide described above. In certain aspects, (a) can contain 4-amino-3-chloro-5-fluoro-6-(7-fluoro-1H-indol-6-yl) picolinic acid or an agriculturally acceptable N-oxide, salt, or ester thereof. In some aspects, (b) can contain a mixture of one or more PDS inhibitor with one or more VLCFA synthesis inhibitor. In some cases, (a) can be applied in an amount of from 0.5 g ae/ha to 50 g ae/ha (e.g., from 5 g ae/ha to 40 g ae/ha) and/or (b) can be applied in an amount of from 12.5 g ai/ha to 6720 g ai/ha (e.g., from 50 g ai/ha to 200 g ai/ha). In some cases, (a) and (b) can be applied in a weight ratio of from 1:14000 to 4:1 (e.g., from 1:7000 to 1:1, from 1:1000 to 2:1, from 1:500 to 3:1, or from 1:175 to 4:1).

The description below sets forth details of one or more aspects of the present disclosure. Other features, objects, and advantages will be apparent from the description and from the claims.

### DETAILED DESCRIPTION OF THE DISCLOSURE

The present disclosure relates to herbicidal compositions containing a herbicidally effective amount of (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof. The present disclosure also relates to methods for controlling undesirable vegetation.

### I. Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

As used herein, the terms “herbicide” and “herbicidal active ingredient” refer to an active ingredient that kills, controls, or otherwise adversely modifies the growth of vegetation, particularly undesirable vegetation, such as weeds, when applied in an appropriate amount.

As used herein, a “herbicidally effective amount” may be understood to include an amount of an active ingredient that causes a “herbicidal effect” or an adversely modifying effect including, for instance, a deviation from natural growth or development, killing, regulation, desiccation, growth inhibition, growth reduction, and retardation.

As used herein, applying a herbicide or herbicidal composition may be understood to include delivering it directly to the targeted vegetation or to the locus thereof or to the area where control of undesired vegetation is desired. Methods of application include, but are not limited to pre-emergently contacting soil or water, post-emergently contacting the undesirable vegetation or area adjacent to the undesirable vegetation.

As used herein, the terms “crops” and “vegetation” can include, for instance, dormant seeds, germinant seeds, emerging seedlings, plants emerging from vegetative propagules, immature vegetation, and established vegetation.

As used herein, immature vegetation may be understood to include small vegetative plants prior to reproductive stage, and mature vegetation may be understood to include vegetative plants during and after the reproductive stage.

As used herein, unless otherwise specified, the term “acyl” may be understood to include a group of formula —C(O)R, where R is hydrogen, alkyl (e.g., C₁-C₁₀ alkyl), haloalkyl (C₁-C₈ haloalkyl), alkenyl (C₂-C₈ alkenyl), haloalkenyl (e.g., C₂-C₈ haloalkenyl), alkynyl (e.g., C₂-C₈ alkynyl), alkoxy (C₁-C₈ alkoxy), haloalkoxy (C₁-C₈ alkoxy), aryl, or heteroaryl, arylalkyl (C₇-C₁₀ arylalkyl), as defined below, where “C(O)” or “CO” is short-hand notation for C═O. In some aspects, the acyl group can be a C₁-C₆ acyl group (e.g., a formyl group, a C₁-C₅ alkylcarbonyl group, or a C₁-C₅ haloalkylcarbonyl group). In some aspects, the acyl group can be a C₁-C₃ acyl group (e.g., a formyl group, a C₁-C₃ alkylcarbonyl group, or a C₁-C₃ haloalkylcarbonyl group).

As used herein, the term “alkyl” may be understood to include saturated, straight-chained or branched saturated hydrocarbon moieties. Unless otherwise specified, C₁-C₂₀ (e.g., C₁-C₁₂, C₁-C₁₀, C₁-C₈, C₁-C₆, C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “haloalkyl” may be understood to include straight-chained or branched alkyl groups, wherein these groups the hydrogen atoms may partially or entirely be substituted with halogen atoms. Unless otherwise specified, C₁-C₂₀ (e.g., C₁-C₁₂, C₁-C₁₀, C₁-C₈, C₁-C₆, C₁-C₄) alkyl groups are intended. Examples include chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, and 1,1,1-trifluoroprop-2-yl. Haloalkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkenyl” may be understood to include unsaturated, straight-chained, or branched hydrocarbon moieties containing a double bond. Unless otherwise specified, C₂-C₂₀ (e.g., C₂-C₁₂, C₂-C₁₀, C₂-C₈, C₂-C₆, C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” may be understood to include a group having the structure —CH═CH₂; 1-propenyl may be understood to include a group with the structure —CH═CH—CH₃; and 2-propenyl may be understood to include a group with the structure —CH₂—CH═CH₂. Alkenyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

The term “haloalkenyl,” as used herein, may be understood to include an alkenyl group, as defined above, which is substituted by one or more halogen atoms.

As used herein, the term “alkynyl” represents straight-chained or branched hydrocarbon moieties containing a triple bond. Unless otherwise specified, C₂-C₂₀ (e.g., C₂-C₁₂, C₂-C₁₀, C₂-C₈, C₂-C₆, C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkoxy” may be understood to include a group of the formula R—O—, where R is unsubstituted or substituted alkyl as defined above. Unless otherwise specified, alkoxy groups wherein R is a C₁-C₂₀ (e.g., C₁-C₁₂, C₁-C₁₀, C₁-C₈, C₁-C₆, C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-dimethyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

As used herein, the term “haloalkoxy” may be understood to include a group of the formula R—O—, where R is unsubstituted or substituted haloalkyl as defined above. Unless otherwise specified, haloalkoxy groups wherein R is a C₁-C₂₀ (e.g., C₁-C₁₂, C₁-C₁₀, C₁-C₈, C₁-C₆, C₁-C₄) alkyl group are intended. Examples include chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, and 1,1,1-trifluoroprop-2-oxy.

As used herein, the term “alkylthio” may be understood to include a group of the formula R—S—, where R is unsubstituted or substituted alkyl as defined above. Unless otherwise specified, alkylthio groups wherein R is a C₁-C₂₀ (e.g., C₁-C₁₂, C₁-C₁₀, C₁-C₈, C₁-C₆, C₁-C₄) alkyl group are intended. Examples include methylthio, ethylthio, propylthio, 1-methylethylthio, butylthio, 1-methyl-propylthio, 2-methylpropylthio, 1,1-dimethylethylthio, pentylthio, 1-methylbutylthio, 2-methylbutylthio, 3-methylbutylthio, 2,2-dimethylpropylthio, 1-ethylpropylthio, hexylthio, 1,1-dimethylpropylthio, 1,2-dimethylpropylthio, 1-methylpentylthio, 2-methylpentylthio, 3-methyl-pentylthio, 4-methyl-pentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio, and 1-ethyl-2-methylpropylthio.

As used herein, the term “haloalkylthio” may be understood to include an alkylthio group as defined above wherein the carbon atoms are partially or entirely substituted with halogen atoms. Unless otherwise specified, haloalkylthio groups wherein R is a C₁-C₂₀ (e.g., C₁-C₁₂, C₁-C₁₀, C₁-C₈, C₁-C₆, C₁-C₄) alkyl group are intended. Examples include chloromethylthio, bromomethylthio, dichloromethylthio, trichloromethylthio, fluoromethylthio, difluoromethylthio, trifluoromethylthio, chlorofluoromethylthio, dichlorofluoromethylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2-difluoroethylthio, 2,2-dichloro-2-fluoroethylthio, 2,2,2-trichloroethylthio, pentafluoroethylthio, and 1,1,1-trifluoroprop-2-ylthio.

As used herein, the term “aryl,” as well as derivative terms such as aryloxy, may be understood to include groups that include a monovalent aromatic carbocyclic group of from 6 to 14 carbon atoms. Aryl groups can include a single ring or multiple condensed rings. In some aspects, aryl groups include C₆-C₁₀ aryl groups. Examples of aryl groups include, but are not limited to, phenyl, biphenyl, naphthyl, tetrahydronaphthyl, phenylcyclopropyl, and indanyl. In some aspects, the aryl group can be a phenyl, indanyl or naphthyl group. The term “heteroaryl”, as well as derivative terms such as “heteroaryloxy”, may be understood to include a 5- or 6-membered aromatic ring containing one or more heteroatoms, viz., N, O or S; these heteroaromatic rings may be fused to other aromatic systems. The aryl or heteroaryl substituents may be unsubstituted or substituted with one or more chemical moieties. Examples of suitable substituents include, for example, hydroxy, nitro, cyano, formyl, C₁-C₆ alkyl, C₂-C₆ alkenyl, C₂-C₆ alkynyl, C₁-C₆ alkoxy, C₁-C₆ haloalkyl, C₁-C₆ haloalkoxy, C₁-C₆ acyl, C₁-C₆ alkylthio, C₁-C₆ alkylsulfinyl, C₁-C₆ alkylsulfonyl, C₁-C₆ alkoxycarbonyl, C₁-C₆ carbamoyl, hydroxycarbonyl, C₁-C₆ alkylcarbonyl, aminocarbonyl, C₁-C₆ alkylaminocarbonyl, C₁-C₆ dialkylaminocarbonyl, provided that the substituents are sterically compatible and the rules of chemical bonding and strain energy are satisfied. Preferred substituents include halogen, C₁-C₂ alkyl and C₁-C₂ haloalkyl.

As used herein, the term “alkylcarbonyl” may be understood to include an unsubstituted or substituted alkyl group bonded to a carbonyl group. C₁-C₃ alkylcarbonyl and C₁-C₃ haloalkylcarbonyl refer to groups wherein a C₁-C₃ unsubstituted or substituted alkyl or haloalkyl group is bonded to a carbonyl group (the group contains a total of 2 to 4 carbon atoms).

As used herein, the term “alkoxycarbonyl” may be understood to include a group of the formula

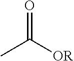

wherein R is unsubstituted or substituted alkyl.

As used herein, the term “arylalkyl” may be understood to include an alkyl group substituted with an unsubstituted or substituted aryl group. C₇-C₁₀ arylalkyl may be understood to include a group wherein the total number of carbon atoms in the group is 7 to 10, not including the carbon atoms present in any substituents of the aryl group.

As used herein, the term “alkylamino” may be understood to include an amino group substituted with one or two unsubstituted or substituted alkyl groups, which may be the same or different.

As used herein, the term “haloalkylamino” may be understood to include an alkylamino group wherein the alkyl carbon atoms are partially or entirely substituted with halogen atoms.

As used herein, C₁-C₆ alkylaminocarbonyl may be understood to include a group of the formula RNHC(O)— wherein R is C₁-C₆ unsubstituted or substituted alkyl, and C₁-C₆ dialkylaminocarbonyl may be understood to include a group of the formula R₂NC(O)— wherein each R is independently C₁-C₆ unsubstituted or substituted alkyl.

As used herein, the term “alkylcarbamyl” may be understood to include a carbamyl group substituted on the nitrogen with an unsubstituted or substituted alkyl group.

As used herein, the term “alkylsulfonyl” may be understood to include a group of the formula

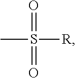

where R is unsubstituted or substituted alkyl.

As used herein, the term “carbamyl” (also referred to as carbamoyl and aminocarbonyl) may be understood to include a group of the formula

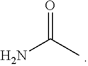

As used herein, the term “dialkylphosphonyl” may be understood to include a group of the formula

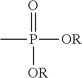

where R is independently unsubstituted or substituted alkyl in each occurrence.

As used herein, C₁-C₆ trialkylsilyl may be understood to include a group of the formula —SiR₃ wherein each R is independently a C₁-C₆ unsubstituted or substituted alkyl group (the group contains a total of 3 to 18 carbon atoms).

As used herein, Me may be understood to include a methyl group; OMe may be understood to include a methoxy group; and i-Pr may be understood to include an isopropyl group.

As used herein, the term “halogen” including derivative terms such as “halo” may be understood to include fluorine, chlorine, bromine and iodine.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Compounds described herein can include N-oxides. Pyridine N-oxides can be obtained by oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f.

Pyridine Carboxylic Acid Herbicides

Compositions and methods of the present disclosure can include a pyridine carboxylic acid herbicide of Formula (I)

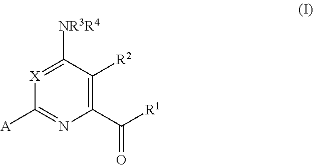

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

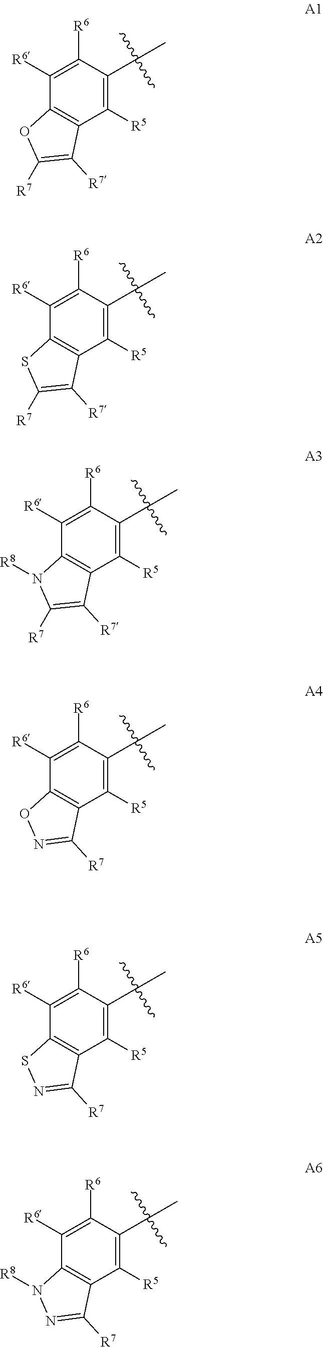

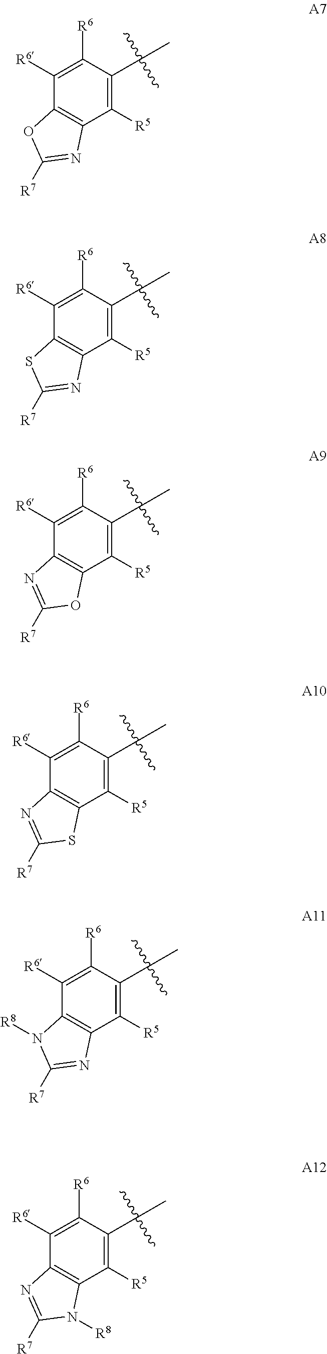

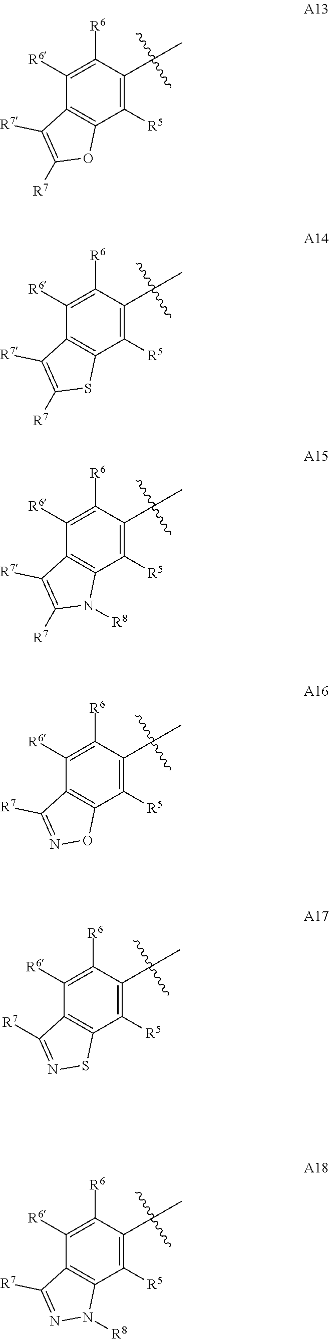

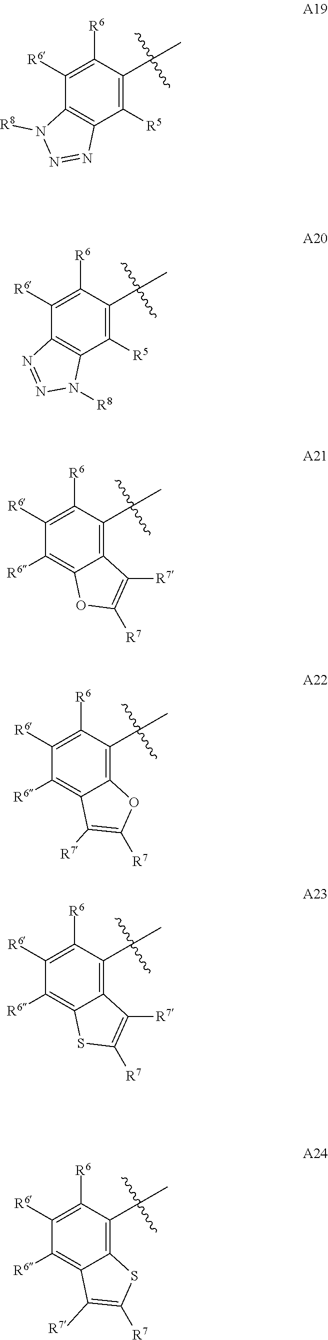

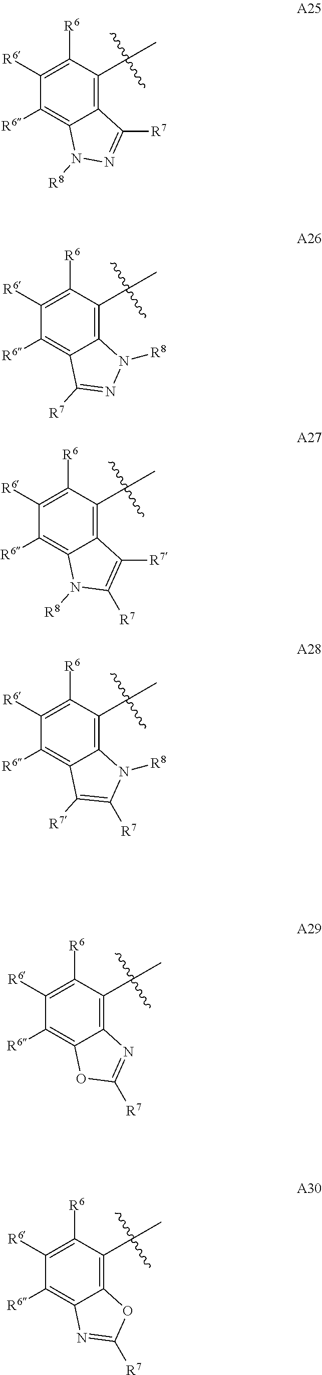

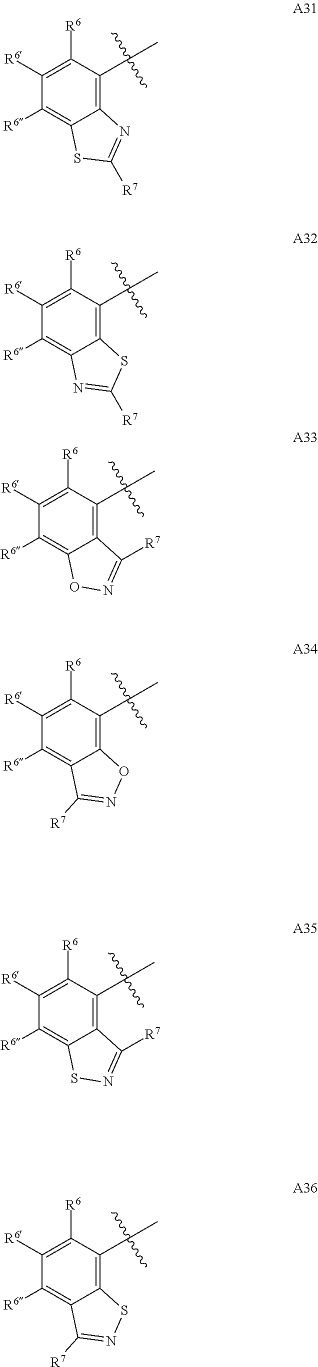

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In some aspects, R¹ is OR^{1′}, wherein R^{1′} is hydrogen, C₁-C₈ alkyl, or C₇-C₁₀ arylalkyl. In some aspects, R^{1′} is hydrogen or C₁-C₈ alkyl. In some aspects, R^{1′} is hydrogen.

In some aspects, R² is halogen, C₁-C₄ alkyl, C₁-C₄ haloalkyl, C₂-C₄ alkynyl, C₂-C₄ alkenyl, C₂-C₄ haloalkenyl, C₁-C₄-alkoxy, or C₁-C₄ haloalkoxy. In some aspects, R² is halogen, C₂-C₄ alkenyl, C₂-C₄ haloalkenyl, or C₁-C₄-alkoxy. In some aspects, R² is halogen. In some aspects, R² is C₂-C₄ alkenyl or C₂-C₄ haloalkenyl. In some aspects, R² is C₁-C₄ alkoxy. In some aspects, R² is Cl, OMe, vinyl, or 1-propenyl. In some aspects, R² is Cl. In some aspects, R² is OMe. In some aspects, R² is vinyl or 1-propenyl.

In some aspects, R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy, or C₁-C₆ alkylamino. In some aspects, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₁-C₆ alkoxy or C₁-C₆ alkylamino. In some aspects, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, or C₁-C₃ haloalkylcarbonyl. In some aspects, at least one of R³ and R⁴ are hydrogen. In some aspects, R³ and R⁴ are both hydrogen.

In some aspects, X is N, CH or CF. In some aspects, X is N. In some aspects, X is CH. In some aspects, X is CF. In other aspects, X is C—CH₃.

In some aspects, A is A1, A2, A3, A4, A5, A6, A7, A8, A9, A10, A11, A12, A13, A14, A15, A16, A17, A18, A19, or A20. In other aspects, A is one of A21, A22, A23, A24, A25, A26, A27, A28, A29, A30, A31, A32, A33, A34, A35, and A36.

In some aspects, A is one of groups A1, A2, A3, A7, A8, A9, A10, A13, A14, and A15. In some aspects, A is one of groups A1, A2, A3, A13, A14, and A15. In some aspects, A is one of groups A13, A14, and A15. In some aspects, A is A15.

In some aspects, R⁵ is hydrogen, halogen, C₁-C₄ alkyl, C₁-C₄ haloalkyl, C₁-C₃ alkoxy, C₁-C₃ haloalkoxy, C₁-C₃ alkylthio, C₁-C₃ haloalkylthio, or amino. In some aspects, R⁵ is hydrogen, halogen, C₁-C₄ alkyl, C₁-C₄ haloalkyl, C₁-C₃ alkoxy, C₁-C₃ haloalkoxy, or amino. In some aspects, R⁵ is hydrogen, halogen, C₁-C₄ alkyl or C₁-C₄ alkoxy. In some aspects, R⁵ is hydrogen or F. In some aspects, R⁵ is hydrogen.

In other aspects, R⁵ is F.

In some aspects, R⁶ is hydrogen, halogen, C₁-C₄ alkyl, C₁-C₄ haloalkyl, C₁-C₃ alkoxy, or C₁-C₃ haloalkoxy. In some aspects, R⁶ is hydrogen or fluorine. In some aspects, R⁶ is hydrogen. In some aspects, R⁶ is fluorine.

In some aspects, R^{6′} is hydrogen or halogen. In some aspects, R^{6′} is hydrogen, F, or Cl. In some aspects, R^{6′} is hydrogen or F. In some aspects, R^{6′} is hydrogen.

In some aspects, R^{6″} is hydrogen, halogen, C₁-C₄ alkyl, C₁-C₄ haloalkyl, cyclopropyl, C₂-C₄ alkynyl, CN, or NO₂. In some aspects, R^{6″} is hydrogen. In some aspects, R^{6″} is halogen. In some aspects, R^{6″} is C₁-C₄ alkyl. In some aspects, R^{6″} is C₁-C₄ haloalkyl. In some aspects, R^{6″} is cyclopropyl. In some aspects, R^{6″} is C₂-C₄ alkynyl. In some aspects, R^{6″} is CN. In some aspects, R^{6″} is NO₂.

In some aspects:

X is N, CH, CF, CC1, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, or C₁-C₃ alkylamino, or phenyl; and

R⁸ is hydrogen, C₁-C₃ alkyl, phenyl, or C₁-C₃ alkylcarbonyl.

In some aspects, R² is halogen, C₂-C₄ alkenyl, C₂-C₄ haloalkenyl, or C₁-C₄-alkoxy; R³ and R⁴ are both hydrogen; and X is N, CH, or CF.

In some aspects, R² is halogen; R³ and R⁴ are both hydrogen; and X is N, CH, or CF.

In some aspects, R² is C₂-C₄ alkenyl or C₂-C₄ haloalkenyl; R³ and R⁴ are both hydrogen; and X is N, CH, or CF.

In some aspects, R² is C₁-C₄ alkoxy; R³ and R⁴ are both hydrogen; and X is N, CH, or CF.

In some aspects, R² is halogen, C₂-C₄ alkenyl, C₂-C₄ haloalkenyl, or C₁-C₄-alkoxy; R³ and R⁴ are both hydrogen; X is N, CH, or CF; R⁵ is hydrogen or F; R⁶ is hydrogen or F; R^{6′} is hydrogen; R^{6″}, if applicable to the relevant A group, is hydrogen or halogen; and R⁷ and R^{7′}, if applicable to the relevant A group, are independently hydrogen or halogen.

In some aspects, R² is halogen, C₁-C₄ alkoxy, or C₂-C₄ alkenyl; R³ and R⁴ are hydrogen; X is N, CH, or CF; and A is one of groups A1 to A20.

In some aspects, R² is chlorine; R³ and R⁴ are hydrogen; X is N, CH, or CF; A is one of groups A1 to A20; R⁵ is hydrogen or F; R⁶ and R^{6′} are independently hydrogen or F; and R⁷ and R^{7′}, if applicable to the relevant A group, are independently hydrogen, halogen, C₁-C₄ alkyl, or C₁-C₄ haloalkyl.

In some aspects, R² is chlorine, methoxy, vinyl, or 1-propenyl; R³ and R⁴ are hydrogen; and X is N, CH, or CF.

In some aspects, R² is chlorine; R³ and R⁴ are hydrogen; and X is N, CH, or CF.

In some aspects, R² is vinyl or 1-propenyl; R³ and R⁴ are hydrogen; and X is N, CH, or CF.

In some aspects, R² is methoxy; R³ and R⁴ are hydrogen; and X is N, CH, or CF.

In some aspects, R² is chlorine; R³ and R⁴ are hydrogen; and X is N.

In some aspects, R² is chlorine; R³ and R⁴ are hydrogen; and X is CH.

In some aspects, R² is chlorine; R³ and R⁴ are hydrogen; and X is CF.

In some aspects, R² is chlorine; R³ and R⁴ are hydrogen; X is CF; A is one of A1, A2, A3, A7, A8, A9, A10, A13, A14, or A15; R⁵ is F; and R⁶ is H.

In some aspects, R² is chlorine, methoxy, vinyl, or 1-propenyl; R³ and R⁴ are hydrogen; X is N, CH, or CF; and A is one of A21-A36.

In some aspects, R² is chlorine, methoxy, vinyl, or 1-propenyl; R³ and R⁴ are hydrogen; X is CF; and A is one of

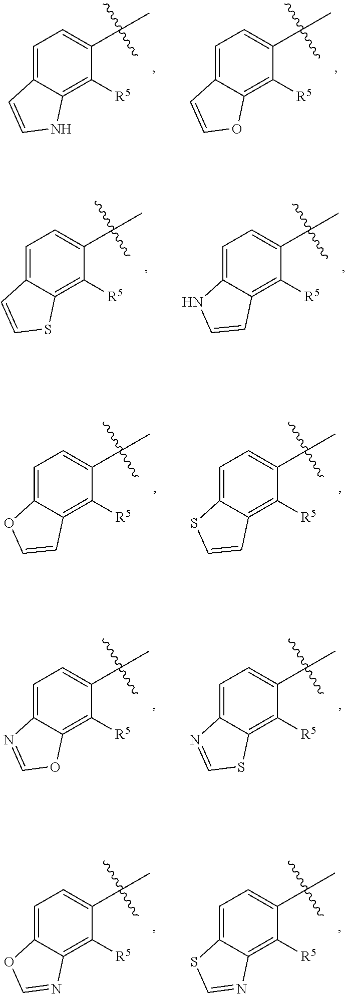

wherein R⁵ is hydrogen or F.

In some aspects, R² is chlorine, methoxy, vinyl, or 1-propenyl; R³ and R⁴ are hydrogen; X is N, CH, or CF; and A is

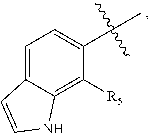

where R⁵ is hydrogen or F.

In some aspects, R² is chlorine, methoxy, vinyl, or 1-propenyl; R³ and R⁴ are hydrogen; X is N, CH, or CF; and A is

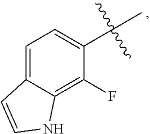 [SMILES: *c1ccc2cc[nH]c2c1F]

In some aspects, R² is chlorine, methoxy, vinyl, or 1-propenyl; R³ and R⁴ are hydrogen; X is CF; and A is

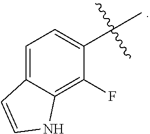 [SMILES: *c1ccc2cc[nH]c2c1F]

In some aspects, the pyridine carboxylic acid herbicide can contain a compound defined by Formula (I)

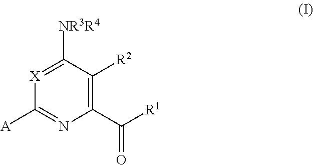

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof,

with the proviso that the pyridine carboxylic acid herbicide is not a compound defined by Formula (I)

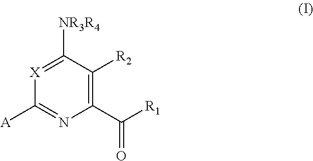

wherein

X is N, CH, CF, CC1, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, C₁-C₃ alkylamino, or phenyl; and

R⁸ is hydrogen, C₁-C₃ alkyl, phenyl, or C₁-C₃ alkylcarbonyl;

or an agriculturally acceptable N-oxide, salt, or ester thereof.

In some of these aspects, R¹ is OR¹. In some of these aspects, X is CF. In some of these aspects, A is A15. In some of these aspects, R⁵ is F.

In some aspects:

X is CY, wherein Y is C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is F, Br, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio; R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ alkylthio, C₁-C₃ haloalkylthio, C₂-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently C₁-C₄ alkyl, C₁-C₄ haloalkyl, halocyclopropyl, C₃-C₄ alkenyl, C₂-C₄ haloalkenyl, C₂-C₄ alkynyl, C₁-C₃ haloalkoxy, C₁-C₃ alkylthio, C₁-C₃ haloalkylthio, C₁-C₄ alkylamino or C₂-C₄ haloalkylamino, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, or A18;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ haloalkylthio, amino, C₄ alkylamino, or C₂-C₄ haloalkylamino; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these aspects, R¹ is OR¹. In some of these aspects, X is CF. In some of these aspects, A is A15. In some of these aspects, R⁵ is F.

In some aspects:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A3, A6, A11, A12, A15, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is C₃-C₆ alkyl, C₁-C₆ haloalkyl, C₃-C₆ alkenyl, C₃-C₆ haloalkenyl, C₃-C₆ alkynyl, formyl, C₁-C₃ haloalkylcarbonyl, C₁-C₆ alkoxycarbonyl, C₁-C₆ alkylcarbamyl, C₁-C₆ alkylsulfonyl, or C₁-C₆ trialkylsilyl.

In some of these aspects, R¹ is OR¹. In some of these aspects, X is CF. In some of these aspects, A is A15. In some of these aspects, R⁵ is F.

In certain aspects, the pyridine carboxylic acid herbicide is a compound of Formula (II):

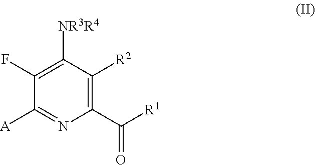

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In some aspects:

R¹ is OR^{1′}, wherein R^{1′} is hydrogen, C₁-C₈ alkyl, or C₇-C₁₀ arylalkyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, or C₁-C₄ haloalkylthio.

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

A is A1, A2, A3, A7, A8, A9, A10, A11, A12, A13, A14, A15, A21, A22, A23, A24, A27, A28, A29, A30, A31, or A32;

R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some aspects, R¹ is OR^{1′}, wherein R^{1′} is hydrogen, C₁-C₈ alkyl, or C₇-C₁₀ arylalkyl.

In some aspects, R² is halogen, C₂-C₄ alkenyl, C₂-C₄ haloalkenyl, or C₁-C₄ alkoxy. In certain aspects, R² is Cl, methoxy, vinyl, or 1-propenyl. In some aspects, R³ and R⁴ are hydrogen.

In some aspects, A is A1, A2, A3, A7, A8, A9, A10, A13, A14, or A15. In certain aspects, A is A1, A2, A3, A13, A14, or A15. In certain aspects, A is A15.

In some aspects, R⁵ is hydrogen or F. In certain aspects, R⁵ is F. In certain aspects, R⁵ is H.

In some aspects, R⁶ is hydrogen or F. In certain aspects, R⁶ is F. In certain aspects, R⁶ is H. In some aspects, R^{6″} is hydrogen, halogen, C₁-C₄ alkyl, C₁-C₄ haloalkyl, cyclopropyl, C₂-C₄ alkynyl, CN, or NO₂. In certain aspects, R⁶, R^{6′}, and R^{6″} are all hydrogen.

In certain aspects, R² is Cl, methoxy, vinyl, or 1-propenyl; R³ and R⁴ are hydrogen; A is A15; R⁵ is hydrogen or F; R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain aspects, the pyridine carboxylic acid herbicide is a compound of Formula (III):

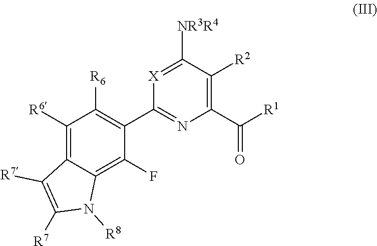

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide, salt, or ester thereof.

In some aspects:

X is N, CH, CF, CCl, or CBr;

R¹ is OR^{1′}, wherein R^{1′} is hydrogen, C₁-C₈ alkyl, or C₇-C₁₀ arylalkyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, or C₁-C₄ haloalkylthio;

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some aspects, X is N, CH or CF. In some aspects, X is N. In some aspects, X is CH. In some aspects, X is CF. In other aspects, X is C—CH₃.

In some aspects, R² is halogen, C₂-C₄ alkenyl, C₂-C₄ haloalkenyl, or C₁-C₄ alkoxy. In certain aspects, R² is Cl, methoxy, vinyl, or 1-propenyl. In some aspects, R³ and R⁴ are hydrogen.

In some aspects, R⁶ is hydrogen or F. In certain aspects, R⁶ is F. In certain aspects, R⁶ is H. In some aspects, R^{6′} is hydrogen, halogen, C₁-C₄ alkyl, C₁-C₄ haloalkyl, cyclopropyl, C₂-C₄ alkynyl, CN, or NO₂. In certain aspects, R⁶ and R^{6′} are both hydrogen.

In certain aspects, R⁷ and R^{7′} are both hydrogen.

In certain aspects, R⁶, R^{6′}, R⁷, and R^{7′} are all hydrogen.

In certain aspects, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain aspects, the pyridine carboxylic acid herbicide can contain one of Compounds 1-7, the structures of which are shown in the table below.

| Compound | |
|---|---|
| No. | Structure |
| 1 | 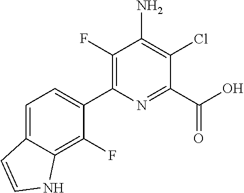 [SMILES: Nc1c(F)c(-c2ccc3cc[nH]c3c2F)nc(C(=O)O)c1Cl] |
| 2 | 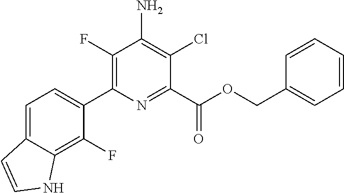 [SMILES: Nc1c(F)c(-c2ccc3cc[nH]c3c2F)nc(C(=O)OCc2ccccc2)c1Cl] |
| 3 | 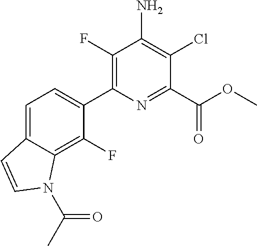 [SMILES: COC(=O)c1nc(-c2ccc3ccn(C(C)=O)c3c2F)c(F)c(N)c1Cl] |
| 4 | 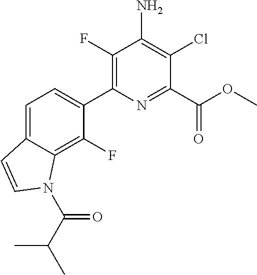 [SMILES: COC(=O)c1nc(-c2ccc3ccn(C(=O)C(C)C)c3c2F)c(F)c(N)c1Cl] |
| 5 | 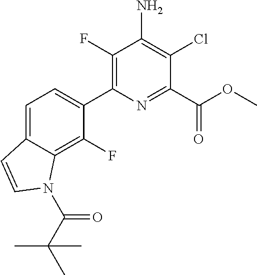 [SMILES: COC(=O)c1nc(-c2ccc3ccn(C(=O)C(C)(C)C)c3c2F)c(F)c(N)c1Cl] |
| 6 | 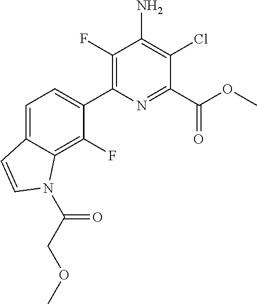 [SMILES: COCC(=O)n1ccc2ccc(-c3nc(C(=O)OC)c(Cl)c(N)c3F)c(F)c21] |
| 7 | 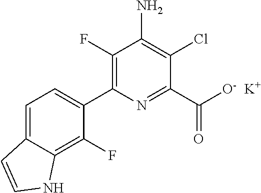 [SMILES: Nc1c(F)c(-c2ccc3cc[nH]c3c2F)nc(C(=O)[O-])c1Cl ; [K+]] |

In certain aspects, the pyridine carboxylic acid herbicide can contain 4-amino-3-chloro-5-fluoro-6-(7-fluoro-1H-indol-6-yl) picolinic acid or an agriculturally acceptable N-oxide, salt, or ester thereof.

In some aspects, the pyridine carboxylic acid herbicide can be provided as an agriculturally acceptable salt. Exemplary agriculturally acceptable salts of the pyridine carboxylic acid herbicides include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, olamine salts, diglycolamine salts, choline salts, and quaternary ammonium salts such as those represented by the formula R⁹R¹⁰R¹¹R¹²N⁺ and wherein R⁹, R¹⁰, R¹¹ and R¹² (e.g., R⁹-R¹²) each independently can represent hydrogen, C₁-C₁₀ alkyl, C₂-C₈ alkenyl, C₂-C₈ alkynyl, C₁-C₈ alkoxy, C₁-C₈ alkylthio, or aryl groups, provided that R⁹-R¹² are sterically compatible.

In some aspects, the pyridine carboxylic acid herbicide can be provided as an agriculturally acceptable ester. Suitable esters include, but are not limited to, C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl, butoxyethyl esters, substituted or unsubstituted aryl esters, orthoesters, and substituted or unsubstituted arylalkyl esters. In some aspects, the ester can contain a C₁-C₈ alkyl ester, wherein the C₁-C₈ alkyl group is optionally substituted with one or more moieties selected from the group of cyano, C₂-C₈ alkoxy, and C₂-C₈ alkylsulfonyl. For example, the ester can contain a methyl, —CH₂CN, —CH₂OCH₃, —CH₂OCH₂CH₂OCH₃, or —CH₂CH₂SO₂CH₃ ester.

In some aspects, the ester can contain a substituted or unsubstituted benzyl ester. In some aspects, the ester can contain a benzyl ester optionally substituted with one or more moieties selected from the group of halogen, C₁-C₂ alkyl, C₁-C₂ haloalkyl, and combinations thereof. In some aspects, the ester can contain a methyl ester.

The pyridine carboxylic acid herbicide, or an agriculturally acceptable N-oxide, salt, or ester thereof, can be applied to vegetation or an area adjacent the vegetation or applied to soil or water to prevent the emergence or growth of vegetation in an amount sufficient to induce a herbicidal effect. In some aspects, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 0.5 g ae/ha or greater (e.g., 0.6 g ae/ha or greater, 0.7 g ae/ha or greater, 0.8 g ae/ha or greater, 0.9 g ae/ha or greater, 1 g ae/ha or greater, 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 21 g ae/ha or greater, 22 g ae/ha or greater, 23 g ae/ha or greater, 24 g ae/ha or greater, 25 g ae/ha or greater, 26 g ae/ha or greater, 27 g ae/ha or greater, 28 g ae/ha or greater, 29 g ae/ha or greater, 30 g ae/ha or greater, 31 g ae/ha or greater, 32 g ae/ha or greater, 33 g ae/ha or greater, 34 g ae/ha or greater, 35 g ae/ha or greater, 36 g ae/ha or greater, 37 g ae/ha or greater, 38 g ae/ha or greater, 39 g ae/ha or greater, 40 g ae/ha or greater, 41 g ae/ha or greater, 42 g ae/ha or greater, 43 g ae/ha or greater, 44 g ae/ha or greater, 45 g ae/ha or greater, 46 g ae/ha or greater, 47 g ae/ha or greater, 48 g ae/ha or greater, or 49 g ae/ha or greater).

In some aspects, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 50 g ae/ha or less (e.g., 49 g ae/ha or less, 48 g ae/ha or less, 47 g ae/ha or less, 46 g ae/ha or less, 45 g ae/ha or less, 44 g ae/ha or less, 43 g ae/ha or less, 42 g ae/ha or less, 41 g ae/ha or less, 40 g ae/ha or less, 39 g ae/ha or less, 38 g ae/ha or less, 37 g ae/ha or less, 36 g ae/ha or less, 35 g ae/ha or less, 34 g ae/ha or less, 33 g ae/ha or less, 32 g ae/ha or less, 31 g ae/ha or less, 30 g ae/ha or less, 29 g ae/ha or less, 28 g ae/ha or less, 27 g ae/ha or less, 26 g ae/ha or less, 25 g ae/ha or less, 24 g ae/ha or less, 23 g ae/ha or less, 22 g ae/ha or less, 21 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, 1.1 g ae/ha or less, 1 g ae/ha or less, 0.9 g ae/ha or less, 0.8 g ae/ha or less, 0.7 g ae/ha or less, or 0.6 g ae/ha or less).

The pyridine carboxylic acid herbicide or an agriculturally acceptable N-oxide, salt, or ester thereof can be applied to vegetation or an area adjacent the vegetation or applied to soil or water to prevent the emergence or growth of vegetation in an amount ranging from any of the minimum values described above to any of the maximum values described above. In some aspects, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of from 0.5-50 g ae/ha (e.g., from 0.5-5 g ae/ha, from 2.5-40 g ae/ha, from 0.5-40 g ae/ha, from 0.5-2.5 g ae/ha, from 2-50 g ae/ha, from 5-50 g ae/ha, from 5-40 g ae/ha, from 30-40 g ae/ha, or from 5-15 g ae/ha). In some aspects, the pyridine carboxylic acid herbicide, or an agriculturally acceptable N-oxide, salt, or ester thereof, is applied in an amount from 30-40 g ae/ha. In some aspects, the pyridine carboxylic acid herbicide, or an agriculturally acceptable N-oxide, salt, or ester thereof, is applied in an amount from 5-40 g ae/ha.

PDS Inhibitors, VLCFA Synthesis Inhibitors and Mixtures Thereof

In addition to the pyridine carboxylic acid herbicide or agriculturally acceptable N-oxide, salt or ester thereof, the compositions can include a phytoene desaturase (PDS) inhibitor, a very long chain fatty acid (VLCFA) synthesis inhibitor, or mixtures thereof. PDS inhibitors block carotenoid biosynthesis by inhibition of phytoene desaturase, a key enzyme in the carotenoid biosynthesis pathway. An absence of carotenoids leads to destruction of membrane fatty acid and chlorophyll by excessive energy. Examples of PDS inhibitors include, but are not limited to, beflubutamid, diflufenican, fluridone, flurochloridone, flurtamone, norflurazon, and picolinafen.

In some aspects, the composition can include a VLCFA synthesis inhibitor. Very long chain fatty acids have multiple functions in the plant, primarily serving as precursors of cuticle wax biosynthesis, and as components of storage lipids, sphingolipids and phospholipids. Examples of VLCFA synthesis inhibitors include, but are not limited to, acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, and thenylchlor.

The PDS inhibitor, the very long chain fatty acid (VLCFA) synthesis inhibitor, or mixture thereof, can be applied to vegetation or an area adjacent the vegetation or applied to soil or water to prevent the emergence or growth of vegetation in an amount sufficient to induce a herbicidal effect. In some aspects, the PDS inhibitor, the VLCFA synthesis inhibitor, or mixture thereof, is applied to vegetation or an area adjacent the vegetation or applied to soil or water to prevent the emergence or growth of vegetation in an amount of 12.5 g ai/ha or more (e.g., 15 g ai/ha or more, 160 g ai/ha or more, 300 g ai/ha or more, 440 g ai/ha or more, 580 g ai/ha or more, 720 g ai/ha or more, 860 g ai/ha or more, 1000 g ai/ha or more, 1140 g ai/ha or more, 1280 g ai/ha or more, 1420 g ai/ha or more, 1560 g ai/ha or more, 1700 g ai/ha or more, 1840 g ai/ha or more, 1980 g ai/ha or more, 2120 g ai/ha or more, 2260 g ai/ha or more, 2400 g ai/ha or more, 2540 g ai/ha or more, 2680 g ai/ha or more, 2820 g ai/ha or more, 2960 g ai/ha or more, 3100 g ai/ha or more, 3240 g ai/ha or more, 3380 g ai/ha or more, 3520 g ai/ha or more, 3660 g ai/ha or more, 3800 g ai/ha or more, 3940 g ai/ha or more, 4080 g ai/ha or more, 4220 g ai/ha or more, 4360 g ai/ha or more, 4500 g ai/ha or more, 4640 g ai/ha or more, 4780 g ai/ha or more, 4920 g ai/ha or more, 5060 g ai/ha or more, 5200 g ai/ha or more, 5340 g ai/ha or more, 5480 g ai/ha or more, 5620 g ai/ha or more, 5760 g ai/ha or more, 5900 g ai/ha or more, 6040 g ai/ha or more, 6180 g ai/ha or more, 6320 g ai/ha or more, 6460 g ai/ha or more, or 6600 g ai/ha or more).

In some aspects, the PDS inhibitor, the VLCFA synthesis inhibitor, or mixture thereof, is applied to vegetation or an area adjacent the vegetation or applied to soil or water to prevent the emergence or growth of vegetation in an amount of 6720 g ai/ha or less (e.g., 6645 g ai/ha or less, 6575 g ai/ha or less, 6500 g ai/ha or less, 6425 g ai/ha or less, 6350 g ai/ha or less, 6275 g ai/ha or less, 6200 g ai/ha or less, 6125 g ai/ha or less, 6050 g ai/ha or less, 5975 g ai/ha or less, 5900 g ai/ha or less, 5825 g ai/ha or less, 5750 g ai/ha or less, 5675 g ai/ha or less, 5600 g ai/ha or less, 5525 g ai/ha or less, 5450 g ai/ha or less, 5375 g ai/ha or less, 5300 g ai/ha or less, 5225 g ai/ha or less, 5150 g ai/ha or less, 5075 g ai/ha or less, 5000 g ai/ha or less, 4925 g ai/ha or less, 4850 g ai/ha or less, 4775 g ai/ha or less, 4700 g ai/ha or less, 4625 g ai/ha or less, 4550 g ai/ha or less, 4475 g ai/ha or less, 4400 g ai/ha or less, 4325 g ai/ha or less, 4250 g ai/ha or less, 4175 g ai/ha or less, 4100 g ai/ha or less, 4025 g ai/ha or less, 3950 g ai/ha or less, 3875 g ai/ha or less, 3800 g ai/ha or less, 3725 g ai/ha or less, 3650 g ai/ha or less, 3575 g ai/ha or less, 3500 g ai/ha or less, 3425 g ai/ha or less, 3350 g ai/ha or less, 3275 g ai/ha or less, 3200 g ai/ha or less, 3125 g ai/ha or less, 3050 g ai/ha or less, 2975 g ai/ha or less, 2900 g ai/ha or less, 2825 g ai/ha or less, 2750 g ai/ha or less, 2675 g ai/ha or less, 2600 g ai/ha or less, 2525 g ai/ha or less, 2450 g ai/ha or less, 2375 g ai/ha or less, 2300 g ai/ha or less, 2225 g ai/ha or less, 2150 g ai/ha or less, 2075 g ai/ha or less, 2000 g ai/ha or less, 1925 g ai/ha or less, 1850 g ai/ha or less, 1775 g ai/ha or less, 1700 g ai/ha or less, 1625 g ai/ha or less, 1550 g ai/ha or less, 1475 g ai/ha or less, 1400 g ai/ha or less, 1325 g ai/ha or less, 1250 g ai/ha or less, 1175 g ai/ha or less, 1100 g ai/ha or less, 1025 g ai/ha or less, 950 g ai/ha or less, 875 g ai/ha or less, 800 g ai/ha or less, 725 g ai/ha or less, 650 g ai/ha or less, 575 g ai/ha or less, 500 g ai/ha or less, 425 g ai/ha or less, 350 g ai/ha or less, 275 g ai/ha or less, 200 g ai/ha or less, 125 g ai/ha or less, 50 g ai/ha or less, 30 g ai/ha or less, or 15 g ai/ha or less).

The PDS inhibitor, the VLCFA synthesis inhibitor, or mixture thereof, can be applied to vegetation or an area adjacent the vegetation or applied to soil or water to prevent the emergence or growth of vegetation in an amount ranging from any of the minimum values described above to any of the maximum values described above. In some aspects, the PDS inhibitor, the VLCFA synthesis inhibitor, or mixture thereof, is applied to vegetation or an area adjacent the vegetation or applied to soil or water to prevent the emergence or growth of vegetation in an amount of 12.5-6720 g ai/ha (e.g., 12.5-1250 g ai/ha, 1250-1700 g ai/ha, 12.5-1200 g ai/ha, 12.5-1150 g ai/ha, 12.5-1100 g ai/ha, 12.5-1060 g ai/ha, 12.5-1000 g ai/ha, 12.5-900 g ai/ha, 12.5-800 g ai/ha, 12.5-700 g ai/ha, 12.5-600 g ai/ha, 12.5-500 g ai/ha, 12.5-400 g ai/ha, 12.5-280 g ai/ha, 12.5-260 g ai/ha, 12.5-240 g ai/ha, 12.5-220 g ai/ha, 12.5-200 g ai/ha, 12.5-180 g ai/ha, 12.5-160 g ai/ha, 12.5-140 g ai/ha, 12.5-120 g ai/ha, 12.5-100 g ai/ha, 12.5-90 g ai/ha, 12.5-80 g ai/ha, 12.5-70 g ai/ha, 12.5-60 g ai/ha, 12.5-50 g ai/ha, 12.5-40 g ai/ha, 12.5-30 g ai/ha, 12.5 g ai/ha, 12.5-20 g ai/ha, 12.5-560 g ai/ha, 20-500 g ai/ha, 30-460 g ai/ha, 40-400 g ai/ha, 50-360 g ai/ha, 60-300 g ai/ha, 70-280 g ai/ha, 70-100 g ai/ha, 70-140 g ai/ha, 100-140 g ai/ha, 100-280 g ai/ha, or 140-280 g ai/ha).

In certain aspects, the herbicidal composition contains a herbicidally effective amount of (a) a pyridine carboxylic acid herbicide or an agriculturally acceptable N-oxide, salt, or ester thereof, and (b) diflufenican, picolinafen, or flurtamone.

Diflufenican

Compositions and methods of the present disclosure can include diflufenican. Diflufenican, as well as methods of preparing diflufenican, are known in the art. Diflufenican, shown below, is N-(2,4-difluorophenyl)-2-[3-(trifluoromethyl)phenoxy]-3-pyridinecarboxamide. Its herbicidal activity is exemplified in The Pesticide Manual, Fifteenth Edition, 2009. Exemplary uses of diflufenican include its use as a selective contact and residual herbicide that is used pre- and early post-emergence in autumn-sown wheat and barley to control grass and broadleaf weeds. It is typically used in combination with other cereal herbicides, e.g. flufenacet.

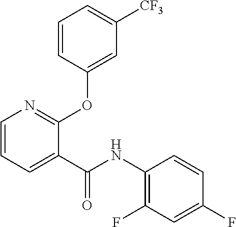 [SMILES: O=C(Nc1ccc(F)cc1F)c1cccnc1Oc1cccc(C(F)(F)F)c1]

The diflufenican can be applied to vegetation or an area adjacent the vegetation or applied to soil or water to prevent the emergence or growth of vegetation in an amount sufficient to induce a herbicidal effect. In some aspects, the diflufenican is applied to vegetation or an area adjacent the vegetation or applied to soil or water to prevent the emergence or growth of vegetation in an amount of 50 g ai/ha or more (e.g., 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, or 185 g ai/ha or more).

In some aspects, the diflufenican is applied to vegetation or an area adjacent the vegetation or applied to soil or water to prevent the emergence or growth of vegetation in an amount of 187.5 g ai/ha or less (e.g., 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, or 55 g ai/ha or less).

The diflufenican can be applied to vegetation or an area adjacent the vegetation or applied to soil or water to prevent the emergence or growth of vegetation in an amount ranging from any of the minimum values described above to any of the maximum values described above. In some aspects, the diflufenican is applied to vegetation or an area adjacent the vegetation or applied to soil or water to prevent the emergence or growth of vegetation in an amount of 50-187.5 g ai/ha (e.g., 55-180 g ai/ha, 60-175 g ai/ha, 65-150 g ai/ha, 70-175 g ai/ha, 75-160 g ai/ha, 80-180 g ai/ha, 80-175 g ai/ha, 85-185 g ai/ha, 85-150 g ai/ha, 90-185 g ai/ha, 90-180 g ai/ha, 90-175 g ai/ha, or 90-170 g ai/ha).

Picolinafen

Compositions and methods of the present disclosure can include picolinafen. Picolinafen, shown below, is N-(4-fluorophenyl)-6-[3-(trifluoromethyl)phenoxy]-2-pyridinecarboxamide. Its herbicidal activity is exemplified in The Pesticide Manual, Fifteenth Edition, 2009. Exemplary uses of picolinafen include its use as a post-emergence herbicide either alone or in mixtures for broad-spectrum weed control in cereals.

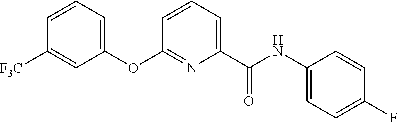 [SMILES: O=C(Nc1ccc(F)cc1)c1cccc(Oc2cccc(C(F)(F)F)c2)n1]

aspect The picolinafen can be applied to vegetation or an area adjacent the vegetation or applied to soil or water to prevent the emergence or growth of vegetation in an amount sufficient to induce a herbicidal effect. In some aspects, the picolinafen is applied to vegetation or an area adjacent the vegetation or applied to soil or water to prevent the emergence or growth of vegetation in an amount of 12.5 g ai/ha or more (e.g., 15 g ai/ha or more, 17.5 g ai/ha or more, 20 g ai/ha or more, 22.5 g ai/ha or more, 25 g ai/ha or more, 27.5 g ai/ha or more, 30 g ai/ha or more, 32.5 g ai/ha or more, 35 g ai/ha or more, 37.5 g ai/ha or more, 40 g ai/ha or more, 42.5 g ai/ha or more, 45 g ai/ha or more, 47.5 g ai/ha or more, 50 g ai/ha or more, 52.5 g ai/ha or more, 55 g ai/ha or more, 57.5 g ai/ha or more, 60 g ai/ha or more, 62.5 g ai/ha or more, 65 g ai/ha or more, 67.5 g ai/ha or more, 70 g ai/ha or more, 72.5 g ai/ha or more, 75 g ai/ha or more, 77.5 g ai/ha or more, 80 g ai/ha or more, 82.5 g ai/ha or more, 85 g ai/ha or more, 87.5 g ai/ha or more, 90 g ai/ha or more, 92.5 g ai/ha or more, 95 g ai/ha or more, or 97.5 g ai/ha or more).

In some aspects, the picolinafen is applied to vegetation or an area adjacent the vegetation or applied to soil or water to prevent the emergence or growth of vegetation in an amount of 100 g ai/ha or less (e.g., 95 g ai/ha or less, 92.5 g ai/ha or less, 90 g ai/ha or less, 87.5 g ai/ha or less, 85 g ai/ha or less, 82.5 g ai/ha or less, 80 g ai/ha or less, 77.5 g ai/ha or less, 75 g ai/ha or less, 72.5 g ai/ha or less, 70 g ai/ha or less, 67.5 g ai/ha or less, 65 g ai/ha or less, 62.5 g ai/ha or less, 60 g ai/ha or less, 57.5 g ai/ha or less, 55 g ai/ha or less, 52.5 g ai/ha or less, 50 g ai/ha or less, 47.5 g ai/ha or less, 45 g ai/ha or less, 42.5 g ai/ha or less, 40 g ai/ha or less, 37.5 g ai/ha or less, 35 g ai/ha or less, 32.5 g ai/ha or less, 30 g ai/ha or less, 27.5 g ai/ha or less, 25 g ai/ha or less, 22.5 g ai/ha or less, 20 g ai/ha or less, 17.5 g ai/ha or less).

The picolinafen can be applied to vegetation or an area adjacent the vegetation or applied to soil or water to prevent the emergence or growth of vegetation in an amount ranging from any of the minimum values described above to any of the maximum values described above. In some aspects, the picolinafen is applied to vegetation or an area adjacent the vegetation or applied to soil or water to prevent the emergence or growth of vegetation in an amount of 12.5-100 g ai/ha (e.g., 15-90 g ai/ha, 20-80 g ai/ha, 25-75 g ai/ha, 25-95 g ai/ha, 25-80 g ai/ha, 30-75 g ai/ha, 35-90 g ai/ha, 40-95 g ai/ha, 40-75 g ai/ha, 45-95 g ai/ha, 45-90 g ai/ha, 50-80 g ai/ha, or 50-75 g ai/ha.

Flurtamone

Compositions and methods of the present disclosure can include flurtamone. Flurtamone, shown below, is (±)-5-(methylamino)-2-phenyl-4-[3-(trifluoromethyl)phenyl]-3(2H)-furanone. Its herbicidal activity is exemplified in The Pesticide Manual, Fifteenth Edition, 2009. Exemplary uses of flurtamone include its use for pre-plant incorporated, pre-emergence or post emergence control of broadleaf and some grass weeds in small grains, peanuts, cotton, peas and sunflowers.

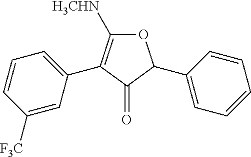

aspect The flurtamone can be applied to vegetation or an area adjacent the vegetation or applied to soil or water to prevent the emergence or growth of vegetation in an amount sufficient to induce a herbicidal effect. In some aspects, the flurtamone is applied to vegetation or an area adjacent the vegetation or applied to soil or water to prevent the emergence or growth of vegetation in an amount of 250 g ai/ha or more (e.g., 255 g ai/ha or more, 260 g ai/ha or more, 265 g ai/ha or more, 270 g ai/ha or more, 275 g ai/ha or more, 280 g ai/ha or more, 285 g ai/ha or more, 290 g ai/ha or more, 295 g ai/ha or more, 300 g ai/ha or more, 305 g ai/ha or more, 310 g ai/ha or more, 315 g ai/ha or more, 320 g ai/ha or more, 325 g ai/ha or more, 330 g ai/ha or more, 335 g ai/ha or more, 340 g ai/ha or more, 345 g ai/ha or more, 350 g ai/ha or more, 355 g ai/ha or more, 360 g ai/ha or more, 365 g ai/ha or more, or 370 g ai/ha or more).

In some aspects, the flurtamone is applied to vegetation or an area adjacent the vegetation or applied to soil or water to prevent the emergence or growth of vegetation in an amount of 375 g ai/ha or less (e.g., 370 g ai/ha or less, 365 g ai/ha or less, 360 g ai/ha or less, 355 g ai/ha or less, 350 g ai/ha or less, 345 g ai/ha or less, 340 g ai/ha or less, 335 g ai/ha or less, 330 g ai/ha or less, 325 g ai/ha or less, 320 g ai/ha or less, 315 g ai/ha or less, 310 g ai/ha or less, 305 g ai/ha or less, 300 g ai/ha or less, 295 g ai/ha or less, 290 g ai/ha or less, 285 g ai/ha or less, 280 g ai/ha or less, 275 g ai/ha or less, 270 g ai/ha or less, 265 g ai/ha or less, 260 g ai/ha or less, or 255 g ai/ha or less).

The flurtamone can be applied to vegetation or an area adjacent the vegetation or applied to soil or water to prevent the emergence or growth of vegetation in an amount ranging from any of the minimum values described above to any of the maximum values described above. In some aspects, the flurtamone is applied to vegetation or an area adjacent the vegetation or applied to soil or water to prevent the emergence or growth of vegetation in an amount of 250-375 g ai/ha (e.g., 255-355 g ai/ha, 260-335 g ai/ha, 265-300 g ai/ha, 265-375 g ai/ha, 270-325 g ai/ha, 270-300 g ai/ha, 275-375 g ai/ha, 275-325 g ai/ha, 275-300 g ai/ha, 280-375 g ai/ha, 280-355 g ai/ha, 280-335 g ai/ha, or 280-325 g ai/ha).

In certain aspects, the herbicidal composition contains a herbicidally effective amount of (a) a pyridine carboxylic acid herbicide or an agriculturally acceptable N-oxide, salt, or ester thereof, and (b) flufenacet or pyroxasulfone, or combinations thereof.

Flufenacet

Compositions and methods of the present disclosure can include flufenacet. Flufenacet, shown below, shown below, is N-(4-fluorophenyl)-N-(1-methylethyl)-2-[[5-(trifluoromethyl)-1,3,4-thiadiazol-2-yl]oxy]acetamide. Its herbicidal activity is exemplified in The Pesticide Manual, Fifteenth Edition, 2009. Exemplary uses of flufenacet include its use for broad-spectrum grass control and control of broadleaf weeds.

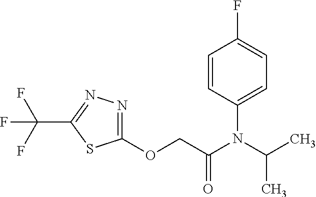 [SMILES: CC(C)N(C(=O)COc1nnc(C(F)(F)F)s1)c1ccc(F)cc1]

aspect The flufenacet can be applied to vegetation or an area adjacent the vegetation or applied to soil or water to prevent the emergence or growth of vegetation in an amount sufficient to induce a herbicidal effect. In some aspects, the flufenacet is applied to vegetation or an area adjacent the vegetation or applied to soil or water to prevent the emergence or growth of vegetation in an amount of 400 g ai/ha or more (e.g., 410 g ai/ha or more, 420 g ai/ha or more, 430 g ai/ha or more, 440 g ai/ha or more, 450 g ai/ha or more, 460 g ai/ha or more, 470 g ai/ha or more, 480 g ai/ha or more, 490 g ai/ha or more, 500 g ai/ha or more, 510 g ai/ha or more, 520 g ai/ha or more, 530 g ai/ha or more, 540 g ai/ha or more, 550 g ai/ha or more, 560 g ai/ha or more, 570 g ai/ha or more, 580 g ai/ha or more, 590 g ai/ha or more, 600 g ai/ha or more, 610 g ai/ha or more, 620 g ai/ha or more, 630 g ai/ha or more, 640 g ai/ha or more, 650 g ai/ha or more, 660 g ai/ha or more, 670 g ai/ha or more, 680 g ai/ha or more, 690 g ai/ha or more, 700 g ai/ha or more, 710 g ai/ha or more, 720 g ai/ha or more, 730 g ai/ha or more, 740 g ai/ha or more, 750 g ai/ha or more, 760 g ai/ha or more, 770 g ai/ha or more, 780 g ai/ha or more, 790 g ai/ha or more, 800 g ai/ha or more, 810 g ai/ha or more, 820 g ai/ha or more, 830 g ai/ha or more, 840 g ai/ha or more, 850 g ai/ha or more, 860 g ai/ha or more, 870 g ai/ha or more, 880 g ai/ha or more, or 890 g ai/ha or more).

In some aspects, the flufenacet is applied to vegetation or an area adjacent the vegetation or applied to soil or water to prevent the emergence or growth of vegetation in an amount of 900 g ai/ha or less (e.g., 890 g ai/ha or less, 880 g ai/ha or less, 870 g ai/ha or less, 860 g ai/ha or less, 850 g ai/ha or less, 840 g ai/ha or less, 830 g ai/ha or less, 820 g ai/ha or less, 810 g ai/ha or less, 800 g ai/ha or less, 790 g ai/ha or less, 780 g ai/ha or less, 770 g ai/ha or less, 760 g ai/ha or less, 750 g ai/ha or less, 740 g ai/ha or less, 730 g ai/ha or less, 720 g ai/ha or less, 710 g ai/ha or less, 700 g ai/ha or less, 690 g ai/ha or less, 680 g ai/ha or less, 670 g ai/ha or less, 660 g ai/ha or less, 650 g ai/ha or less, 640 g ai/ha or less, 630 g ai/ha or less, 620 g ai/ha or less, 610 g ai/ha or less, 600 g ai/ha or less, 590 g ai/ha or less, 580 g ai/ha or less, 570 g ai/ha or less, 560 g ai/ha or less, 550 g ai/ha or less, 540 g ai/ha or less, 530 g ai/ha or less, 520 g ai/ha or less, 510 g ai/ha or less, 500 g ai/ha or less, 490 g ai/ha or less, 480 g ai/ha or less, 470 g ai/ha or less, 460 g ai/ha or less, or 450 g ai/ha or less, 440 g ai/ha or less, 430 g ai/ha or less, 420 g ai/ha or less, or 410 g ai/ha or less).

The flufenacet can be applied to vegetation or an area adjacent the vegetation or applied to soil or water to prevent the emergence or growth of vegetation in an amount ranging from any of the minimum values described above to any of the maximum values described above. In some aspects, the flufenacet is applied to vegetation or an area adjacent the vegetation or applied to soil or water to prevent the emergence or growth of vegetation in an amount of 400-900 g ai/ha (e.g., 400-600 g ai/ha, 650-900 g ai/ha, 400-850 g ai/ha, 400-800 g ai/ha, 400-700 g ai/ha, 500-900 g ai/ha, 500-800 g ai/ha, 500-700 g ai/ha, 600-900 g ai/ha, 600-700 g ai/ha, 450-650 g ai/ha, or 500-600 g ai/ha).

Pyroxasulfone

Compositions and methods of the present disclosure can include pyroxasulfone. Pyroxasulfone, shown below, is 3-[[[5-(difluoromethoxy)-1-methyl-3-(trifluoromethyl)-1H-pyrazol-4-yl]methyl]sulfonyl]-4,5-dihydro-5,5-dimethylisoxazole. Its herbicidal activity is exemplified in The Pesticide Manual, Fifteenth Edition, 2009. Pyroxasulfone provides, e.g., pre-emergence control of annual grasses and some broadleaf weeds in maize, soybeans, wheat and other crops. Pyroxasulfone, as well as methods of preparing pyroxasulfone, are known in the art.

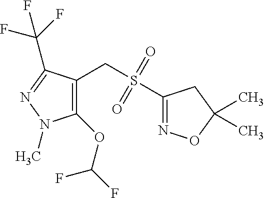 [SMILES: Cn1nc(C(F)(F)F)c(CS(=O)(=O)C2=NOC(C)(C)C2)c1OC(F)F]

aspect The pyroxasulfone can be applied to vegetation or an area adjacent the vegetation or applied to soil or water to prevent the emergence or growth of vegetation in an amount sufficient to induce a herbicidal effect. In some aspects, the pyroxasulfone is applied to vegetation or an area adjacent the vegetation or applied to soil or water to prevent the emergence or growth of vegetation in an amount of 40 g ai/ha or more (e.g., 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, 185 g ai/ha or more, 190 g ai/ha or more, 195 g ai/ha or more, 200 g ai/ha or more, 205 g ai/ha or more, 210 g ai/ha or more, 215 g ai/ha or more, 220 g ai/ha or more, 225 g ai/ha or more, 230 g ai/ha or more, or 235 g ai/ha or more).

In some aspects, the pyroxasulfone is applied to vegetation or an area adjacent the vegetation or applied to soil or water to prevent the emergence or growth of vegetation in an amount of 240 g ai/ha or less (e.g., 235 g ai/ha or less, 230 g ai/ha or less, 225 g ai/ha or less, 220 g ai/ha or less, 215 g ai/ha or less, 210 g ai/ha or less, 205 g ai/ha or less, 200 g ai/ha or less, 195 g ai/ha or less, 190 g ai/ha or less, 185 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, or 45 g ai/ha or less).

The pyroxasulfone can be applied to vegetation or an area adjacent the vegetation or applied to soil or water to prevent the emergence or growth of vegetation in an amount ranging from any of the minimum values described above to any of the maximum values described above. In some aspects, the pyroxasulfone is applied to vegetation or an area adjacent the vegetation or applied to soil or water to prevent the emergence or growth of vegetation in an amount of 40-240 g ai/ha (e.g., 40-230 g ai/ha, 40-220 g ai/ha, 40-210 g ai/ha, 40-200 g ai/ha, 50-240 g ai/ha, 50-230 g ai/ha, 50-220 g ai/ha, 50-210 g ai/ha, 50-200 g ai/ha, 60-240 g ai/ha, 60-230 g ai/ha, 60-220 g ai/ha, 60-210 g ai/ha, or 60-200 g ai/ha).

### II. Compositions

A. Herbicidal Mixtures or Combinations

The (a) pyridine carboxylic acid herbicide or an agriculturally acceptable N-oxide, salt, or ester thereof is mixed with or applied in combination with (b) a phytoene desaturase (PDS) inhibitor, a very long chain fatty acid (VLCFA) synthesis inhibitor, or a mixture thereof. (a) and (b) can be provided in an amount sufficient to induce a herbicidal effect. In some aspects, the joint action of a pyridine carboxylic acid herbicide or an agriculturally acceptable N-oxide, salt, or ester thereof and a phytoene desaturase (PDS) inhibitor, a very long chain fatty acid (VLCFA) synthesis inhibitor, or a mixture thereof, results in enhanced activity against undesired vegetation, even at application rates below those typically used for the pesticide to have a herbicidal effect on its own. In some aspects, the compositions and methods disclosed herein can, based on the individual components, be used at lower application rates to achieve a herbicidal effect comparable to the effect produced by the individual components at normal application rates. In some aspects, the compositions and methods disclosed herein provide an accelerated action on undesired vegetation (e.g., they affect undesired vegetation more quickly compared with application of the individual herbicides).

In some aspects, the weight ratio of (a) a pyridine carboxylic acid herbicide or an agriculturally acceptable N-oxide, salt, or ester thereof (in g ae/ha) to (b) a phytoene desaturase (PDS) inhibitor, a very long chain fatty acid (VLCFA) synthesis inhibitor, or a mixture thereof (in g ai/ha) is 1:14000 or more (e.g., 1:13000 or more, 1:12000 or more, 1:11000 or more, 1:10000 or more, 1:9000 or more, 1:8000 or more, 1:7000 or more, 1:6000 or more, 1:5000 or more, 1:4000 or more, 1:3000 or more, 1:2000 or more, 1:1000 or more, 1:800 or more, 1:700 or more, 1:600 or more, 1:500 or more, 1:400 or more, 1:300 or more, 1:200 or more, 1:100 or more, 1:50 or more, 1:1 or more, 2:1 or more, 3:1 or more, or 4:1 or more).

In some aspects, the weight ratio of (a) a pyridine carboxylic acid herbicide or an agriculturally acceptable N-oxide, salt, or ester thereof (in g ae/ha) to (b) a phytoene desaturase (PDS) inhibitor, a very long chain fatty acid (VLCFA) synthesis inhibitor, or a mixture thereof (in g ai/ha) is 4:1 or less (e.g., 3:1 or less, 2:1 or less, 1:1 or less, 1:50 or less, 1:100 or less, 1:200 or less, 1:300 or less, 1:400 or less, 1:500 or less, 1:600 or less, 1:700 or less, 1:800 or less, 1:900 or less, 1:1000 or less, 1:2000 or less, 1:3000 or less, 1:4000 or less, 1:5000 or less, 1:6000 or less, 1:7000 or less, 1:8000 or less, 1:9000 or less, 1:10000 or less, 1:11000 or less, 1:12000 or less, or 1:13000 or less).

The weight ratio of (a) a pyridine carboxylic acid herbicide or an agriculturally acceptable N-oxide, salt, or ester thereof (in g ae/ha) to (b) a phytoene desaturase (PDS) inhibitor, a very long chain fatty acid (VLCFA) synthesis inhibitor, or a mixture thereof (in g ai/ha) can range from any of the minimum ratios described above to any of the maximum values described above. In some aspects, the weight ratio of (a) a pyridine carboxylic acid herbicide or an agriculturally acceptable N-oxide, salt, or ester thereof (in g ae/ha) to (b) a phytoene desaturase (PDS) inhibitor, a very long chain fatty acid (VLCFA) synthesis inhibitor, or a mixture thereof (in g ai/ha) is from 1:14000 to 4:1 (e.g., from 1:13000 to 3:1, from 1:12000 to 3:1, from 1:11000 to 3:1, from 1:10000 to 3:1, from 1:9000 to 3:1, from 1:8000 to 3:1, from 1:7000 to 3:1, from 1:6000 to 3:1, from 1:5000 to 3:1, from 1:4000 to 3:1, from 1:3000 to 3:1, from 1:2000 to 3:1, from 1:13000 to 2:1, from 1:12000 to 2:1, from 1:11000 to 2:1, from 1:10000 to 2:1, from 1:9000 to 2:1, from 1:8000 to 2:1, from 1:7000 to 2:1, from 1:6000 to 2:1, from 1:5000 to 2:1, from 1:4000 to 2:1, from 1:3000 to 2:1, from 1:2000 to 2:1, from 1:13000 to 1:1, from 1:12000 to 1:1, from 1:11000 to 1:1, from 1:10000 to 1:1, from 1:9000 to 1:1, from 1:8000 to 1:1, from 1:7000 to 1:1, from 1:6000 to 1:1, from 1:5000 to 1:1, from 1:4000 to 1:1, from 1:3000 to 1:1, or from 1:2000 to 1:1).

In some aspects, (b) includes a phytoene desaturase (PDS) inhibitor. In some aspects, the weight ratio of (a) a pyridine carboxylic acid herbicide or an agriculturally acceptable N-oxide, salt, or ester thereof (in g ae/ha) to (b) a phytoene desaturase (PDS) inhibitor (in g ai/ha) is 1:9000 or more (e.g., 1:8000 or more, 1:7000 or more, 1:6000 or more, 1:5000 or more, 1:4000 or more, 1:3000 or more, 1:2000 or more, 1:1000 or more, 1:900 or more, 1:800 or more, 1:700 or more, 1:600 or more, 1:500 or more, 1:400 or more, 1:300 or more, 1:200 or more, 1:100 or more, 1:50 or more, 1:10 or more, 1:1 or more, 2:1 or more, or 3:1 or more). In some aspects, the weight ratio of (a) a pyridine carboxylic acid herbicide or an agriculturally acceptable N-oxide, salt, or ester thereof (in g ae/ha) to (b) a phytoene desaturase (PDS) inhibitor (in g ai/ha) is 4:1 or less (e.g., 3:1 or less, 2:1 or less, 1:1 or less, 1:10 or less, 1:50 or less, 1:100 or less, 1:200 or less, 1:300 or less, 1:400 or less, 1:500 or less, 1:600 or less, 1:700 or less, 1:800 or less, 1:900 or less, 1:1000 or less, 1:2000 or less, 1:3000 or less, 1:4000 or less, 1:5000 or less, 1:6000 or less, 1:7000 or less, or 1:8000 or less).

The weight ratio of (a) a pyridine carboxylic acid herbicide or an agriculturally acceptable N-oxide, salt, or ester thereof to (b) a phytoene desaturase (PDS) inhibitor can range from any of the minimum ratios described above to any of the maximum values described above. In some aspects, the weight ratio of (a) a pyridine carboxylic acid herbicide or an agriculturally acceptable N-oxide, salt, or ester thereof to (b) a phytoene desaturase (PDS) inhibitor is from 1:9000 to 5:1 (e.g., from 1:8000 to 3:1, from 1:7000 to 3:1, from 6000 to 3:1, from 1:5000 to 3:1, from 1:4000 to 3:1, from 1:3000 to 3:1, from 1:2000 to 3:1, from 1:1000 to 3:1, from 1:500 to 3:1, from 1:100 to 3:1, from 1:50 to 3:1, from 1:10 to 3:1, from 1:1 to 3:1, from 1:8000 to 2:1, from 1:7000 to 2:1, from 6000 to 2:1, from 1:5000 to 2:1, from 1:4000 to 2:1, from 1:3000 to 2:1, from 1:2000 to 2:1, from 1:1000 to 2:1, from 1:500 to 2:1, from 1:100 to 2:1, from 1:50 to 2:1, from 1:10 to 2:1, from 1:1 to 2:1, from 1:8000 to 1:1, from 1:7000 to 1:1, from 6000 to 1:1, from 1:5000 to 1:1, from 1:4000 to 1:1, from 1:3000 to 1:1, from 1:2000 to 1:1, from 1:1000 to 1:1, from 1:500 to 1:1, from 1:100 to 1:1, from 1:50 to 1:1, from 1:10 to 1:1, or from 1:5 to 1:1). In certain aspects, the weight ratio of (a) a pyridine carboxylic acid herbicide or an agriculturally acceptable N-oxide, salt, or ester thereof to (b) a phytoene desaturase (PDS) inhibitor is from 1:20 to 5:1, or from 1:10 to 1:1.

In some aspects, (b) includes a very long chain fatty acid (VLCFA) synthesis inhibitor. In some aspects, the weight ratio of (a) a pyridine carboxylic acid herbicide or an agriculturally acceptable N-oxide, salt, or ester thereof (in g ae/ha) to (b) a very long chain fatty acid (VLCFA) synthesis inhibitor (in g ai/ha) is 1:14000 or more (e.g., 1:13000 or more, 1:12000 or more, 1:11000 or more, 1:10000 or more, 1:9000 or more, 1:8000 or more, 1:7000 or more, 1:6000 or more, 1:5000 or more, 1:4000 or more, 1:3000 or more, 1:2000 or more, 1:1000 or more, 1:900 or more, 1:800 or more, 1:700 or more, 1:600 or more, 1:500 or more, 1:400 or more, 1:300 or more, 1:200 or more, 1:100 or more, 1:50 or more, 1:10 or more, 1:1 or more, 1.5:1 or more, or 2:1 or more).

In some aspects, the weight ratio of (a) a pyridine carboxylic acid herbicide or an agriculturally acceptable N-oxide, salt, or ester thereof (in g ae/ha) to (b) a very long chain fatty acid (VLCFA) synthesis inhibitor (in g ai/ha) is 1.5:1 or less (e.g., 1:1 or less, 1:5 or less, 1:10 or less, 1:50 or less, 1:100 or less, 1:500 or less, 1:1000 or less, 1:2000 or less, 1:3000 or less, 1:4000 or less, 1:5000 or less, 1:6000 or less, 1:7000 or less, 1:8000 or less, 1:9000 or less, 1:10000 or less, 1:11000 or less, 1:12000 or less, or 1:13000 or less).

The weight ratio of (a) a pyridine carboxylic acid herbicide or an agriculturally acceptable N-oxide, salt, or ester thereof to (b) a very long chain fatty acid (VLCFA) synthesis inhibitor can range from any of the minimum ratios described above to any of the maximum values described above. In some aspects, the weight ratio of (a) a pyridine carboxylic acid herbicide or an agriculturally acceptable N-oxide, salt, or ester thereof to (b) a very long chain fatty acid (VLCFA) synthesis inhibitor is from 1:14000 to 1.5:1 (e.g., from 1:13000 to 1.25:1, from 1:12000 to 1.25:1, from 1:11000 to 1.25:1, from 1:10000 to 1.25:1, from 1:9000 to 1.25:1, from 1:8000 to 1.25:1, from 1:7000 to 1.25:1, from from 1:6000 to 1.25:1, from 1:5000 to 1.25:1, from 1:4000 to 1.25:1, from from 1:3000 to 1.25:1, from 1:2000 to 1.25:1, from 1:1000 to 1.25:1, from 1:500 to 1.25:1, from 1:100 to 1.25:1, from 1:50 to 1.25:1, from 1:10 to 1.25:1, from 1:1 to 1.25:1 from 1:13000 to 1:1, from 1:12000 to 1:1, from 1:11000 to 1:1, from 1:10000 to 1:1, from 1:9000 to 1:1, from 1:8000 to 1:1, from 1:7000 to 1:1, from from 1:6000 to 1:1, from 1:5000 to 1:1, from 1:4000 to 1:1, from from 1:3000 to 1:1, from 1:2000 to 1:1, from 1:1000 to 1:1, from 1:500 to 1:1, from 1:100 to 1:1, from 1:50 to 1:1, from 1:10 to 1:1, or from 1:5 to 1:1). In certain aspects, the weight ratio of (a) a pyridine carboxylic acid herbicide or an agriculturally acceptable N-oxide, salt, or ester thereof to (b) a very long chain fatty acid (VLCFA) synthesis inhibitor is from 1:30 to 1.5:1, or from 1:20 to 1:6.

In some aspects, the active ingredients in the compositions disclosed herein consist of (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof.

B. Formulations

The present disclosure also relates to formulations of the compositions and methods disclosed herein. In some aspects, the formulation can be in the form of a single package formulation including both (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof. In some aspects, the formulation can be in the form of a single package formulation including both (a) and (b) and further including at least one additive. In some aspects, the formulation can be in the form of a two-package formulation, wherein one package contains (a) and optionally at least one additive while the other package contains (b) and optionally at least one additive. In some aspects of the two-package formulation, the formulation including (a) and optionally at least one additive and the formulation including (b) and optionally at least one additive are mixed before application and then applied simultaneously. In some aspects, the mixing is performed as a tank mix (e.g., the formulations are mixed immediately before or upon dilution with water). In some aspects, the formulation including (a) and the formulation including (b) are not mixed but are applied sequentially (in succession), for example, immediately or within 1 hour, within 2 hours, within 4 hours, within 8 hours, within 16 hours, within 24 hours, within 2 days, or within 3 days, of each other.

In some aspects, the formulation of (a) and (b) is present in suspended, emulsified, or dissolved form. Exemplary formulations include, but are not limited to, aqueous solutions, powders, suspensions, also highly-concentrated aqueous, oily or other suspensions or dispersions, aqueous emulsions, aqueous microemulsions, aqueous suspo-emulsions, oil dispersions, self-emulsifying formulations, pastes, dusts, and materials for spreading or granules.

In some aspects, (a) a pyridine carboxylic acid herbicide or an agriculturally acceptable N-oxide, salt, or ester thereof and/or (b) a phytoene desaturase (PDS) inhibitor, a very long chain fatty acid (VLCFA) synthesis inhibitor, or a mixture thereof is an aqueous solution that can be diluted before use. In some aspects, (a) and/or (b) is provided as a high-strength formulation such as a concentrate. In some aspects, the concentrate is stable and retains potency during storage and shipping. In some aspects, the concentrate is a clear, homogeneous liquid that is stable at temperatures of 54° C. or greater. In some aspects, the concentrate does not exhibit any precipitation of solids at temperatures of −10° C. or higher. In some aspects, the concentrate does not exhibit separation, precipitation, or crystallization of any components at low temperatures. For example, the concentrate remains a clear solution at temperatures below 0° C. (e.g., below −5° C., below −10° C., below −15° C.). In some aspects, the concentrate exhibits a viscosity of less than 50 centipoise (50 megapascals), even at temperatures as low as 5° C.

The compositions and methods disclosed herein can also be mixed with or applied with an additive. In some aspects, the additive can be diluted in water or can be concentrated. In some aspects, the additive is added sequentially. In some aspects, the additive is added simultaneously. In some aspects, the additive is premixed with the pyridine carboxylic acid herbicide or agriculturally acceptable N-oxide, salt, or ester thereof. In some aspects, the additive is premixed with the phytoene desaturase (PDS) inhibitor, a very long chain fatty acid (VLCFA) synthesis inhibitor, or a mixture thereof.

C. Other Actives

In some aspects, the additive is an additional pesticide. For example, the compositions described herein can be applied in conjunction with one or more additional herbicides to control undesirable vegetation. The composition can be formulated with the one or more additional herbicides, tank mixed with the one or more additional herbicides, or applied sequentially with the one or more additional herbicides. Exemplary additional herbicides include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, aminocyclopyrachlor, 4-aminopicolinic acid based herbicides, such as halauxifen, halauxifen-methyl, florpyrauxifen, florpyrauxifen-benzyl, and those described in U.S. Pat. Nos. 7,314,849 and 7,432,227 to Balko, et al., aminopyralid, amiprofos-methyl, amitrole, ammonium sulfamate, anilofos, anisuron, asulam, atraton, atrazine, azafenidin, aziprotryne, barban, BCPC, beflubutamid, benazolin, bencarbazone, benfluralin, benfuresate, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, bixlozone, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlornitrofen, chloropon, chlorotoluron, chloroxuron, chloroxynil, chlorpropham, chlorthal, chlorthiamid, cinidon-ethyl, cinmethylin, cisanilide, clacyfos, clethodim, cliodinate, clodinafop-propargyl, clofop, clomazone, clomeprop, cloprop, cloproxydim, clopyralid, CMA, copper sulfate, CPMF, CPPC, credazine, cresol, cumyluron, cyanatryn, cyanazine, cycloate, cyclopyranil, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethidimuron, ethiolate, ethobenzamid, etobenzamid, ethofumesate, ethoxyfen, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, fluazifop, fluazifop-P-butyl, fluazolate, fluchloralin, flufenacet, flufenican, flufenpyr-ethyl, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, fluridone, flurochloridone, fluroxypyr, fluroxypyr-meptyl, flurtamone, fluthiacet, fomesafen, fosamine, fumiclorac, furyloxyfen, glufosinate, glufosinate-ammonium, glufosinate-P-ammonium, glyphosate salts and esters, halosafen, haloxydine, hexachloroacetone, hexaflurate, hexazinone, indanofan, indaziflam, iodobonil, iodomethane, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lancotrione, lenacil, linuron, MAA, MAMA, MCPA esters and amines, MCPA-thioethyl, MCPB, mecoprop, mecoprop-P, medinoterb, mefenacet, mefluidide, mesoprazine, mesotrione, metam, metamifop, metamitron, metazachlor, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metoxuron, metribuzin, molinate, monalide, monisouron, monochloroacetic acid, monolinuron, monuron, morfamquat, MSMA, naproanilide, napropamide, napropamide-M, naptalam, neburon, nipyraclofen, nitralin, nitrofen, nitrofluorfen, norflurazon, noruron, OCH, orbencarb, ortho-dichlorobenzene, oryzalin, oxadiargyl, oxadiazon, oxapyrazon, oxaziclomefone, oxyfluorfen, paraflufen-ethyl, parafluron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, procyazine, prodiamine, profluazol, profluralin, profoxydim, proglinazine, prohexadione-calcium, prometon, prometryn, pronamide, propachlor, propanil, propaquizafop, propazine, propham, propisochlor, propyzamide, prosulfalin, prosulfocarb, proxan, prynachlor, pydanon, pyraclonil, pyraflufen-ethyl, pyrasulfotole, pyrazogyl, pyrazolynate, pyrazoxyfen, pyributicarb, pyriclor, pyridafol, pyridate, quinclorac, quinmerac, quinoclamine, quinonamid, quizalofop, quizalofop-P-ethyl, rhodethanil, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfosate, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiameturon, thiazafluron, thiazopyr, thidiazimin, thidiazuron, thiobencarb, tiafenacil, tiocarbazil, tioclorim, tolpyralate, topramezone, tralkoxydim, tri-allate, triafamone, triaziflam, tricamba, triclopyr choline salt, triclopyr esters and amines, tridiphane, trietazine, trifluralin, trifop, trifopsime, trihydroxytriazine, trimeturon, tripropindan, tritac, vernolate, xylachlor and salts, esters, optically active isomers, and mixtures thereof.

In some aspects, the additional pesticide or an agriculturally acceptable salt or ester thereof is provided in a premixed formulation with (a), (b), or combinations thereof. In some aspects, the pyridine carboxylic acid herbicide or an agriculturally acceptable N-oxide, salt, or ester thereof is provided in a premixed formulation with an additional pesticide. In some aspects, the phytoene desaturase (PDS) inhibitor, a very long chain fatty acid (VLCFA) synthesis inhibitor, or a mixture thereof is provided in a premixed formulation with an additional pesticide. In some aspects, the diflufenican, the picolinafen, or the flurtamone, is provided in a premixed formulation with an additional pesticide. In some aspects, the flufenacet or the pyroxasulfone is provided in a premixed formulation with an additional pesticide.

D. Adjuvants/Carriers/Colorants/Adhesives

In some aspects, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof.

Exemplary agriculturally acceptable adjuvants include, but are not limited to, crop oil concentrate (mineral oil (85%)+emulsifiers (15%)) or less, nonylphenol ethoxylate or less, benzylcocoalkyldimethyl quaternary ammonium salt or less, blend of petroleum hydrocarbon, alkyl esters, organic acid, and anionic surfactant or less, C₉-C₁₁ alkylpolyglycoside or less, phosphate alcohol ethoxylate or less, natural primary alcohol (C₁₂-C₁₆) ethoxylate or less, di-sec-butylphenol EO-PO block copolymer or less, polysiloxane-methyl cap or less, nonylphenol ethoxylate+urea ammonium nitrate or less, emulsified methylated seed oil or less, tridecyl alcohol (synthetic) ethoxylate (8 EO) or less, tallow amine ethoxylate (15 EO) or less, and PEG(400) dioleate-99.

In some aspects, the additive is a safener, which is an organic compound leading to better crop plant compatibility when applied with a herbicide. In some aspects, the safener itself is herbicidally active. In some aspects, the safener acts as an antidote or antagonist in the crop plants and can reduce or prevent damage to the crop plants. Exemplary safeners include, but are not limited to, AD-67 (MON 4660), benoxacor, benthiocarb, brassinolide, cloquintocet (mexyl), cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro [4.5]decane, oxabetrinil, R29148, and N-phenyl-sulfonylbenzoic acid amides, such as metcamifen, as well as agriculturally acceptable salts thereof and, provided they have a carboxyl group, their agriculturally acceptable derivatives. In some aspects, the safener can be cloquintocet or an ester or salt or ester thereof, such as cloquintocet (mexyl). In some aspects, the safener can be dichlormid. In some aspects, the safener is employed in rice, cereal, corn, or maize. For example, dichlormid or cloquintocet can be used to antagonize harmful effects of the compositions on rice, row crops, and cereals.

Exemplary surfactants (e.g., wetting agents, tackifiers, dispersants, emulsifiers) include, but are not limited to, the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof.

Exemplary thickeners include, but are not limited to, polysaccharides, such as xanthan gum, and organic and inorganic sheet minerals, and mixtures thereof.

Exemplary antifoam agents include, but are not limited to, silicone emulsions, long-chain alcohols, fatty acids, salts of fatty acids, organofluorine compounds, and mixtures thereof.

Exemplary antimicrobial agents include, but are not limited to, bactericides based on dichlorophen and benzyl alcohol hemiformal, and isothiazolinone derivates, such as alkylisothiazolinones and benzisothiazolinones, and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

In some aspects, the additive includes a carrier. In some aspects, the additive includes a liquid or solid carrier. In some aspects, the additive includes an organic or inorganic carrier. Exemplary liquid carriers include, but are not limited to, petroleum fractions or hydrocarbons such as mineral oil, aromatic solvents, paraffinic oils, and the like or less, vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like or less, esters of the above vegetable oils or less, esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like or less, esters of mono, di and polycarboxylic acids and the like, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like, and water as well as mixtures thereof. Exemplary solid carriers include, but are not limited to, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

In some aspects, emulsions, pastes or oil dispersions can be prepared by homogenizing (a) and (b) in water by means of wetting agent, tackifier, dispersant or emulsifier. In some aspects, concentrates suitable for dilution with water are prepared, containing (a), (b), a wetting agent, a tackifier, and a dispersant or emulsifier.

In some aspects, powders or materials for spreading and dusts can be prepared by mixing or concomitant grinding of (a) and (b) and optionally a safener with a solid carrier.

In some aspects, granules (e.g., coated granules, impregnated granules and homogeneous granules) can be prepared by binding the (a) and (b) to solid carriers.

The formulations disclosed herein can contain a herbicidally effective amount of (a) and (b). In some aspects, the concentrations of (a) and (b) in the formulations can be varied. In some aspects, the formulations contain from 1% to 95% (e.g., from 5% to 95%, from 10% to 80%, from 20% to 70%, from 30% to 50%) by total weight of (a) and (b). In formulations designed to be employed as concentrates, (a) and (b) can be present in a concentration of from 0.1 to 98 weight percent (0.5 to 90 weight percent), based on the total weight of the formulation. Concentrates can be diluted with an inert carrier, such as water, prior to application. The diluted formulations applied to undesired vegetation or the locus of undesired vegetation can contain from 0.0006 to 8.0 weight percent of (a) and (b) (e.g., from 0.001 to 5.0 weight percent), based on the total weight of the diluted formulation.

In some aspects, (a) and (b), independently, can be employed in a purity of from 90% to 100% (e.g., from 95% to 100%) according to nuclear magnetic resonance (NMR) spectrometry. In some aspects, the concentrations of (a), (b), and additional pesticides in the formulations can be varied. In some aspects, the formulations contain from 1% to 95% (e.g., from 5% to 95%, from 10% to 80%, from 20% to 70%, from 30% to 50%) by total weight of (a), (b), and additional pesticides. In some aspects, (a), (b), and additional pesticides, independently, can be employed in a purity of from 90% to 100% (e.g., from 95% to 100%) according to NMR spectrometry.

### III. Methods of Use

A. Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In some aspects, the method of application can be chosen to ensure the finest possible distribution of the compositions disclosed herein.

In some aspects, a method of controlling undesirable vegetation which contains contacting the vegetation or the locus thereof with or applying to the soil or water to prevent the emergence or growth of vegetation any of the compositions is disclosed herein.

The compositions disclosed herein can be applied pre-emergence (before the emergence of undesirable vegetation) or post-emergence (e.g., during and/or after emergence of the undesirable vegetation). If desired, the compositions can be applied as an in-water application. In some aspects, the pyridine carboxylic acid herbicide or or an agriculturally acceptable N-oxide, salt, or ester thereof and the phytoene desaturase (PDS) inhibitor, a very long chain fatty acid (VLCFA) synthesis inhibitor, or a mixture thereof are applied simultaneously.

When the compositions are used in crops, the compositions can be applied after seeding and before or after the emergence of the crop plants. In some aspects, the compositions disclosed herein show good crop tolerance even when the crop has already emerged and can be applied during or after the emergence of the crop plants. In some aspects, when the compositions are used in crops, the compositions can be applied before seeding of the crop plants.

In some aspects, the compositions disclosed herein are applied to vegetation or an area adjacent the vegetation or applied to soil or water to prevent the emergence or growth of vegetation by spraying (e.g., foliar spraying). In some aspects, the spraying techniques use, for example, water as carrier and spray liquor rates of from 10 liters per hectare (L/ha) to 2000 L/ha (e.g., from 50 L/ha to 1000 L/ha or from 100 to 500 L/ha). In some aspects, the compositions disclosed herein are applied by the low-volume or the ultra-low-volume method, wherein the application is in the form of micro granules. In some aspects, wherein the compositions disclosed herein are less well tolerated by certain crop plants, the compositions can be applied with the aid of the spray apparatus in such a way that they come into little contact, if any, with the leaves of the sensitive crop plants while reaching the leaves of undesirable vegetation that grows underneath or the bare soil (e.g., post-directed or lay-by). In some aspects, the compositions disclosed herein can be applied as dry formulations (e.g., granules, WDGs, etc.) into water.

In some aspects, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some aspects, these and other factors can be adjusted to promote non-selective or selective herbicidal action. In some cases, the compositions are applied to relatively immature undesirable vegetation.

The compositions and methods disclosed herein can be used to control undesired vegetation in a variety of crop and non-crop applications. In some aspects, the compositions and methods disclosed herein can be used for controlling undesired vegetation in crops. Exemplary crops include, but are not limited to, wheat, barley, triticale, rye, teff, oats, maize, cotton, soy, sorghum, rice, sugarcane and range land (e.g., pasture grasses). In some aspects, the undesirable vegetation is controlled in a row crop (e.g., maize, sorghum, soybean, cotton, or oilseed rape/canola). In some aspects, the compositions and methods disclosed herein can be used for controlling undesired vegetation in maize, wheat, rice, barley, or a combination thereof.

The compositions and methods disclosed herein can be used for controlling undesired vegetation in non-crop areas. Exemplary non-crop areas include, but are not limited to, turfgrass, pastures, grasslands, fallow land, rights-of-way, aquatic settings, tree and vine, wildlife management areas, or rangeland. In some aspects, the compositions and methods disclosed herein can be used in industrial vegetation management (IVM) or for utility, pipeline, roadside, and railroad rights-of-way applications. In some aspects, the compositions and methods disclosed herein can also be used in forestry (e.g., for site preparation or for combating undesirable vegetation in plantation forests). In some aspects, the compositions and methods disclosed herein can be used to control undesirable vegetation in conservation reserve program lands (CRP), trees, vines, grasslands, and grasses grown for seeds. In some aspects, the compositions and methods disclosed herein can be used on lawns (e.g., residential, industrial, and institutional), golf courses, parks, cemeteries, athletic fields, and sod farms.

The compositions and methods disclosed herein can also be used in crop plants that are resistant to, for instance, herbicides, pathogens, and/or insects. In some aspects, the compositions and methods disclosed herein can be used in crop plants that are resistant to one or more herbicides because of genetic engineering or breeding. In some aspects, the compositions and methods disclosed herein can be used in crop plants that are resistant to one or more pathogens such as plant pathogenous fungi owing to genetic engineering or breeding. In some aspects, the compositions and methods disclosed herein can be used in crop plants that are resistant to attack by insects owing to genetic engineering or breeding. Exemplary resistant crops include, but are not limited to, crops that are resistant to photosystem II inhibitors, or crop plants that, owing to introduction of the gene for Bacillus thuringiensis (or Bt) toxin by genetic modification, are resistant to attack by certain insects. In some aspects, the compositions and methods described herein also can be used in conjunction with glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, and bromoxynil to control vegetation in crops tolerant to glyphosate, glufosinate, dicamba, phenoxy auxins, pyridyloxy auxins, aryloxyphenoxypropionates, ACCase inhibitors, HPPD inhibitors, PPO inhibitors, triazines, bromoxynil, or combinations thereof. In some aspects, the undesirable vegetation is controlled in glyphosate, glufosinate, dicamba, phenoxy auxins, pyridyloxy auxins, aryloxyphenoxypropionates, ACCase inhibitors, HPPD inhibitors, PPO inhibitors, triazines, and bromoxynil tolerant crops possessing single, multiple or stacked traits conferring tolerance to single or multiple chemistries and/or multiple modes of action. In some aspects, the undesirable vegetation can be controlled in a crop that is ACCase-tolerant. The combination of (a), (b), and a complementary herbicide or salt or ester thereof can be used in combination with herbicides that are selective for the crop being treated and which complement the spectrum of weeds controlled by these compounds at the application rate employed. In some aspects, the compositions described herein and other complementary herbicides are applied at the same time, either as a combination formulation or as a tank mix, or as sequential applications.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

In some aspects, the compositions disclosed herein can be used for controlling undesirable vegetation including grasses, broadleaf weeds, sedge weeds, and combinations thereof. In some aspects, the compositions disclosed herein can be used for controlling undesirable vegetation including, but not limited to, Polygonum species such as wild buckwheat (Polygonum convolvolus), blackgrass (Alopecurus myosuroide), Amaranthus species such as pigweed (Amaranthus retroflexus), wild oat (Avena fatua), rutabaga (Brassica napus var. napobrassica), Chenopodium species such as common lambsquarters (Chenopodium album L.), Sida species such as prickly sida (Sida spinosa L.), Ambrosia species such as common ragweed (Ambrosia artemisiifolia), Cyperus species such as nutsedge (Cyperus esculentus), barnyardgrass (Echinochloa crus-galli), poinsettia (Euphorbia heterophylla), soybean (Glycine max), ivyleaf morningglory (Ipomoea hederacea), grain sorghum (Sorghum vulgare), Setaria species such as giant foxtail (Setaria faberi), Sorghum species, Acanthospermum species, Anthemis species, Atriplex species, Brassica species, Cirsium species, Convolvulus species, Conyza species, such as horseweed (Conyza canadensis), Cassia species, Commelina species, Datura species, Euphorbia species, Geranium species, Galinsoga species, Ipomea species such as morning-glory, Lamium species, Malva species, Matricaria species, Persicaria species, Prosopis species, Rumex species, Sisymbrium species, Solanum species, Trifolium species, Xanthium species, Veronica species, Viola species such as wild pansy (Viola tricolor), common chickweed (Stellaria media), velvetleaf (Abutilon theophrasti), hemp sesbania (Sesbania exaltata Cory), Anoda cristata, Bidens pilosa, Brassica kaber, shepherd's purse (Capsella bursa-pastoris), cornflower (Centaurea cyanus or Cyanus segetum), Galeopsis tetrahit, cleavers Galium aparine), Helianthus annuus, Desmodium tortuosum, kochia (Kochia scoparia), Medicago arabica, Mercurialis annua, Myosotis arvensis, common poppy (Papaver rhoeas), Raphanus raphanistrum, Russian thistle (Salsola kali), wild mustard (Sinapis arvensis), Sonchus arvensis, Thlaspi arvense, Tagetes minuta, Richardia brasiliensis, Plantago major, Plantago lanceolata, bird's-eye speedwell (Veronica persica) and speedwell.

In certain aspects, the undesirable vegetation includes velvetleaf (Abutilon theophrasti, ABUTH), pigweed (Amaranthus retroflexus, AMARE), spring rape (Brassica napus, BRSNN), common lambsquarters (Chenopodium album L., CHEAL), thistle (Cirsium arvense CIRAR), nutsedge (Cyperus esculentus, CYPES), large crabgrass (Digitaria sanguinalis, DIGSA), barnyardgrass (Echinochloa crus-galli, ECHCG), poinsettia (Euphorbia heterophylla, EPHHL), ivyleaf morningglory (Ipomoea hederacea, IPOHE), ivyleaf speedwell (Veronica hederifolia, VERHE), kochia (Kochia scoparia, KCHSC), wild buckwheat (Polygonum convolvulus, POLCO), grain sorghum (Sorghum vulgare, SORVU), common chickweed (Stellaria media, STEME), wild pansy (Viola tricolor, VIOTR), or a combination thereof.

The herbicidal compositions described herein can be used to control herbicide resistant or tolerant weeds. The methods employing the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinyl(oxy/thio)benzoates, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes-of-action, and biotypes with multiple resistance or tolerance mechanisms (e.g., target site resistance or metabolic resistance).

By way of non-limiting illustration, examples of certain aspects of the present disclosure are given below.

### EXAMPLES

### Example 1. Herbicidal Activity and Effect on Crop Injury on Weeds of Compound 1 and Phytoene Desaturase Inhibitor Herbicides, Very Long Chain Fatty Acid Inhibitor Herbicides, and Mixtures Thereof, in Greenhouse Trials

### Methodology—Evaluation of Postemergence Herbicidal Activity in Crops

Seeds of the desired test plant species were planted in Sun Gro MetroMix® 360 planting mixture, which typically has a pH of 6.0 to 6.8 and an organic matter content of about 30 percent, in plastic pots with a surface area of 103.2 square centimeters (cm²). When required to ensure good germination and healthy plants, a fungicide treatment and/or other chemical or physical treatment was applied. The plants were grown for 7-36 days (d) in a greenhouse with an approximate 14-hour (h) photoperiod which was maintained at about 23° C. during the day and 22° C. during the night. Nutrients and water were added on a regular basis and supplemental lighting was provided with overhead metal halide 1000-Watt lamps as necessary. The plants were employed for testing when they reached the second or third true leaf stage.

Weighed amounts of technical material were dissolved in a volume of 97:3 volume per volume (v/v) acetone/dimethyl sulfoxide (DMSO) to make stock solutions. If the experimental compound did not dissolve readily, the mixture was warmed and/or sonicated. The concentrated stock solutions were diluted with an aqueous mixture of 1.5% v/v of Agri-dex crop oil concentrate to provide the appropriate application rates. Compound requirements are based upon a 12 milliliter (mL) application volume at a rate of 187 liters per hectare (UJha). Spray solutions of the experimental compound mixtures were prepared by adding the stock solutions to the appropriate amount of dilution solution to form a 12 mL spray solution in two-way combinations. Formulated compounds were applied to the plant material with an overhead Mandel track sprayer equipped with 8002E nozzles calibrated to deliver 187 L/ha over an application area of 0.503 square meters (m²) at a spray height of 18 inches (43 centimeters (cm)) above average plant canopy. Control plants were sprayed in the same manner with the solvent blank. Application rates for component (a) are in g ae/ha, and application rates for component (b) are in g ai/ha.

The treated plants and control plants were placed in a greenhouse as described above and watered by sub-irrigation to prevent wash-off of the test compounds. After 20-22 d, the condition of the test plants as compared with that of the control plants was determined visually and scored on a scale of 0 to 100 percent where 0 corresponds to no injury and 100 corresponds to complete kill. The condition of the test plants was compared with that of the control plants as determined visually and scored on a scale of 0 to 100 percent, where 0 corresponds to no injury and 100 corresponds to complete kill. Colby's equation was used to determine the herbicidal effects expected from the mixtures.

Compound 1 was formulated as an EC and was combined with phytoene desaturase inhibitor herbicides, very long chain fatty acid inhibitor herbicides, or mixtures thereof, and applied to weeds, and the phytotoxicity of the herbicidal composition was measured. The results are summarized in Tables 1-6.

The following abbreviations are used in the tables below.
g ae/ha=grams acid equivalent per hectare
g ai/ha=grams active ingredient per hectare
ABUTH=Abutilon theophrasti (velvetleaf)
AMARE=Amaranthus retroflexus (pigweed)
BRSNN=Brassica napus (spring rape)
CIRAR=Cirsium arvense (thistle)
CHEAL=Chenopodium album L. (common lambsquarters)
CYPES=Cyperus esculentus (nutsedge)
DIGSA=Digitaria sanguinalis (large crabgrass)
ECHCG=Echinochloa crus-galli (barnyardgrass)
EPHHL=Euphorbia heterophylla (poinsettia)
IPOHE=Ipomoea hederacea (ivyleaf morningglory)
KCHSC=Kochia scoparia (kochia)
ORYSA=Oryza sativa (rice)
POLCO=Polygonum convolvulus (wild buckwheat)
SORVU=Sorghum vulgare (grain sorghum)
STEME=Stellaria media (chickweed)
TRZAW=Triticum aestivum (winter wheat)
VERHE=Veronica hederifolia (ivyleaf speedwell)
VIOTR=Viola tricolor (wild pansy)
ZEAMX=Zea mays (maize/corn)

TABLE 1
Herbicidal activity of mixtures of compound 1 with the phytoene
desaturase inhibitor herbicide diflufenican (% visual injury).

| | Compound 1 | | Diflufenican | | Combination | |
|---|---|---|---|---|---|---|
| Weed | | % | | % | Observed | Predicted |
| Bayer | | Visual | | Visual | % Visual | % Visual |
| Code | g ae/ha | Injury | g ai/ha | Injury | Injury | Injury |
| ABUTH | 5 | 10 | 50 | 0 | 20 | 10 |
| BRSNN | 5 | 50 | 50 | 20 | 93 | 60 |
| CIRAR | 5 | 20 | 50 | 20 | 60 | 36 |
| CYPES | 5 | 10 | 50 | 0 | 70 | 10 |
| DIGSA | 5 | 0 | 50 | 10 | 40 | 10 |
| ECHCG | 5 | 60 | 50 | 0 | 80 | 60 |
| EPHHL | 5 | 97 | 50 | 10 | 100 | 97 |
| IPOHE | 5 | 20 | 50 | 0 | 60 | 20 |
| KCHSC | 5 | 65 | 50 | 10 | 75 | 69 |
| POLCO | 5 | 70 | 50 | 10 | 97 | 73 |
| SORVU | 5 | 60 | 50 | 0 | 90 | 60 |
| TRZAW | 5 | 10 | 50 | 0 | 10 | 10 |
| ZEAMX | 5 | 10 | 50 | 5 | 15 | 15 |
| ORYSA | 5 | 0 | 50 | 0 | 10 | 0 |

TABLE 2
Herbicidal activity of mixtures of compound 1 with the phytoene
desaturase inhibitor herbicide picolinafen (% visual injury).

| | | | | | Combination | |
|---|---|---|---|---|---|---|
| | Compound 1 | | Picolinafen | | | Colby |
| Weed | | % | | % | Observed | Predicted |
| Bayer | | Visual | | Visual | % Visual | % Visual |
| Code | g ae/ha | Injury | g ai/ha | Injury | Injury | Injury |
| AMARE | 5 | 93 | 12.5 | 20 | 100 | 94 |
| BRSNN | 5 | 50 | 12.5 | 25 | 93 | 63 |
| CIRAR | 5 | 20 | 12.5 | 10 | 80 | 28 |
| CYPES | 5 | 10 | 12.5 | 0 | 65 | 10 |
| ECHCG | 5 | 60 | 12.5 | 10 | 90 | 64 |
| IPOHE | 5 | 20 | 12.5 | 5 | 95 | 24 |
| POLCO | 5 | 70 | 12.5 | 0 | 100 | 70 |
| SORVU | 5 | 60 | 12.5 | 0 | 70 | 60 |
| VIOTR | 5 | 10 | 12.5 | 10 | 65 | 19 |
| TRZAW | 5 | 10 | 12.5 | 0 | 0 | 10 |
| ZEAMX | 5 | 10 | 12.5 | 5 | 10 | 15 |

TABLE 3
Herbicidal activity of mixtures of compound 1 with
the very long chain fatty acid synthesis inhibitor
herbicide flufenacet (% visual injury).

| | | | | | Combination | |
|---|---|---|---|---|---|---|
| | Compound 1 | | Flufenacet | | | Colby |
| Weed | | % | | % | Observed | Predicted |
| Bayer | | Visual | | Visual | % Visual | % Visual |
| Code | g ae/ha | Injury | g ai/ha | Injury | Injury | Injury |
| ABUTH | 5 | 50 | 60 | 0 | 60 | 50 |
| | 10 | 50 | 60 | 0 | 60 | 50 |
| CHEAL | 5 | 90 | 60 | 10 | 100 | 91 |
| | 10 | 95 | 60 | 10 | 100 | 96 |
| CIRAR | 5 | 50 | 60 | 0 | 50 | 50 |
| | 10 | 60 | 60 | 0 | 65 | 60 |
| EPHHL | 5 | 75 | 60 | 0 | 97 | 75 |
| | 10 | 100 | 60 | 0 | 100 | 100 |

TABLE 4
Herbicidal activity of mixtures of compound 1 with
the very long chain fatty acid synthesis inhibitor
herbicide pyroxasulfone (% visual injury).

| | | | | | Combination | |
|---|---|---|---|---|---|---|
| | Compound 1 | | Pyroxasulfone | | | Colby |
| Weed | | % | | % | Observed | Predicted |
| Bayer | | Visual | | Visual | % Visual | % Visual |
| Code | g ae/ha | Injury | g ai/ha | Injury | Injury | Injury |
| AMARE | 5 | 65 | 100 | 0 | 75 | 65 |
| CHEAL | 5 | 80 | 100 | 10 | 97 | 82 |
| EPHHL | 5 | 97 | 100 | 0 | 100 | 97 |
| KCHSC | 5 | 65 | 100 | 0 | 65 | 65 |
| STEME | 5 | 65 | 100 | 40 | 97 | 79 |
| VERHE | 5 | 40 | 100 | 0 | 65 | 40 |
| VIOTR | 5 | 5 | 100 | 0 | 20 | 5 |

TABLE 5
Herbicidal activity of mixtures of compound
1 with Bacara ™ (Diflufenican +
Flurtamone) (% visual injury).

| | | | | | Combination | |
|---|---|---|---|---|---|---|
| | Compound 1 | | Bacara ™ | | | Colby |
| Weed | | % | | % | Observed | Predicted |
| Bayer | | Visual | | Visual | % Visual | % Visual |
| Code | g ae/ha | Injury | g ai/ha | Injury | Injury | Injury |
| AMARE | 5 | 65 | 180 | 10 | 85 | 69 |
| STEME | 5 | 65 | 180 | 40 | 100 | 79 |
| VERHE | 5 | 40 | 180 | 75 | 100 | 85 |
| VIOTR | 5 | 5 | 180 | 20 | 60 | 24 |

TABLE 6
Herbicidal activity of mixtures of compound 1 with
Bacara Forte ™ (Diflufenican + Flurtamone +
Flufenacet) (% visual injury).

| | | | | | Combination | |
|---|---|---|---|---|---|---|
| | Compound 1 | | Bacara Forte ™ | | | Colby |
| Weed | | % | | % | Observed | Predicted |
| Bayer | | Visual | | Visual | % Visual | % Visual |
| Code | g ae/ha | Injury | g ai/ha | Injury | Injury | Injury |
| AMARE | 5 | 65 | 175 | 0 | 75 | 65 |
| CHEAL | 5 | 80 | 175 | 93 | 100 | 99 |
| EPHHL | 5 | 97 | 175 | 10 | 100 | 97 |
| STEME | 5 | 65 | 175 | 20 | 100 | 72 |
| VIOTR | 5 | 5 | 175 | 30 | 35 | 34 |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including”, “containing”, and variations thereof and are open, non-limiting terms. Although the terms “comprising” and “including” have been used herein to describe various aspects, the terms “consisting essentially of” and “consisting of” can be used in place of “comprising” and “including” to provide for more specific aspects of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A herbicidal composition comprising a herbicidally effective amount of (a) a pyridine carboxylic acid herbicide or an agriculturally acceptable N-oxide, salt, or ester thereof and (b) a phytoene desaturase (PDS) inhibitor, a very long chain fatty acid (VLCFA) synthesis inhibitor, or a mixture thereof,
wherein the pyridine carboxylic acid herbicide comprises a compound defined by Formula (I) 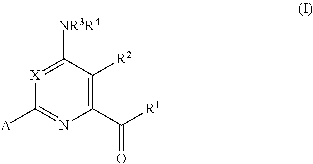
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 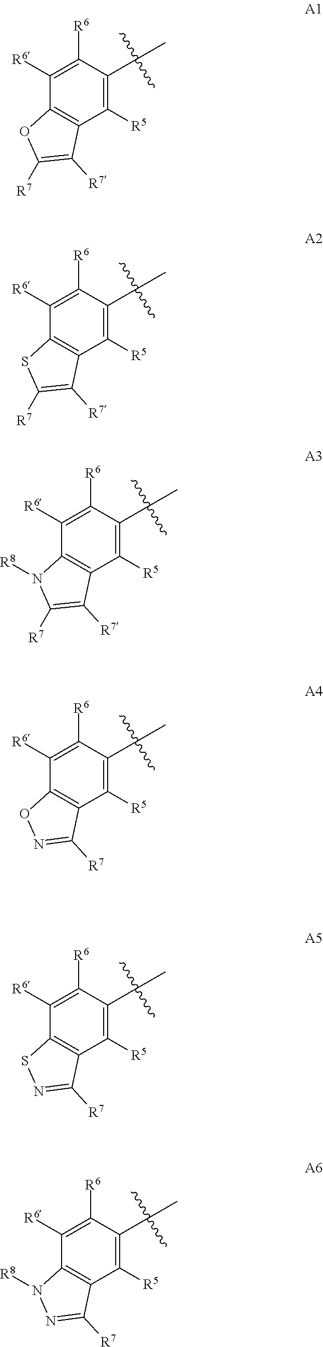 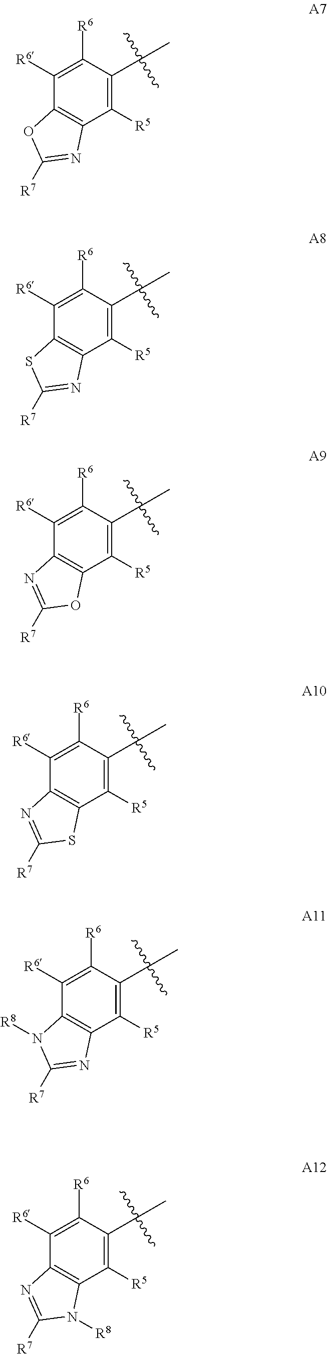 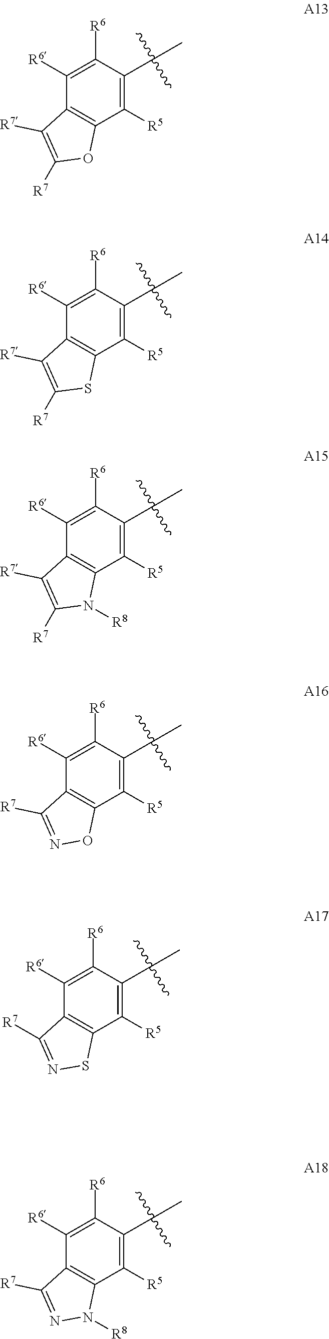 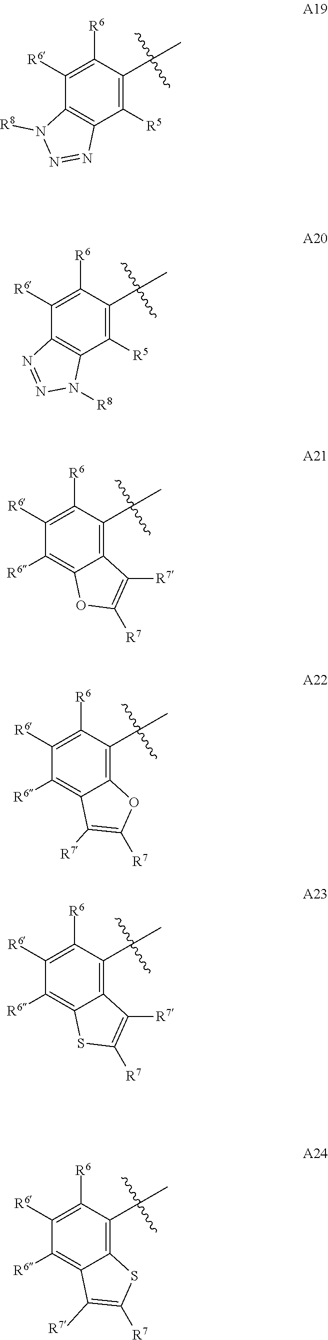 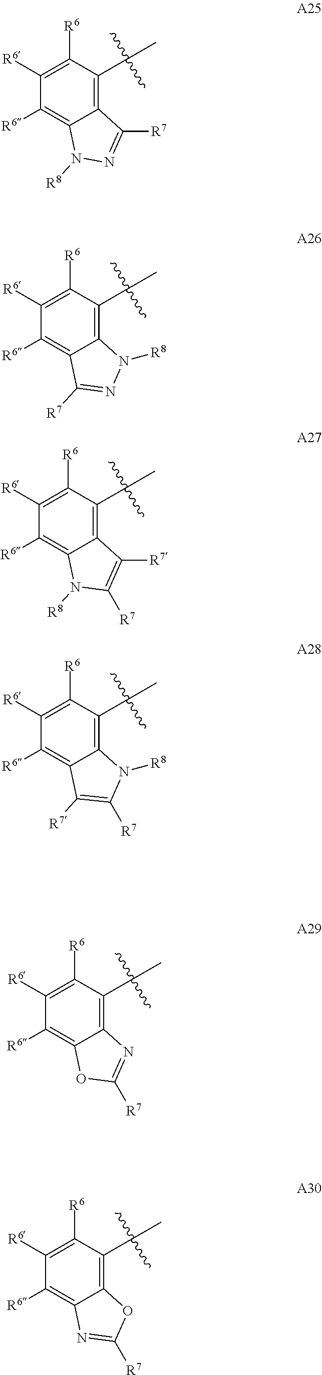 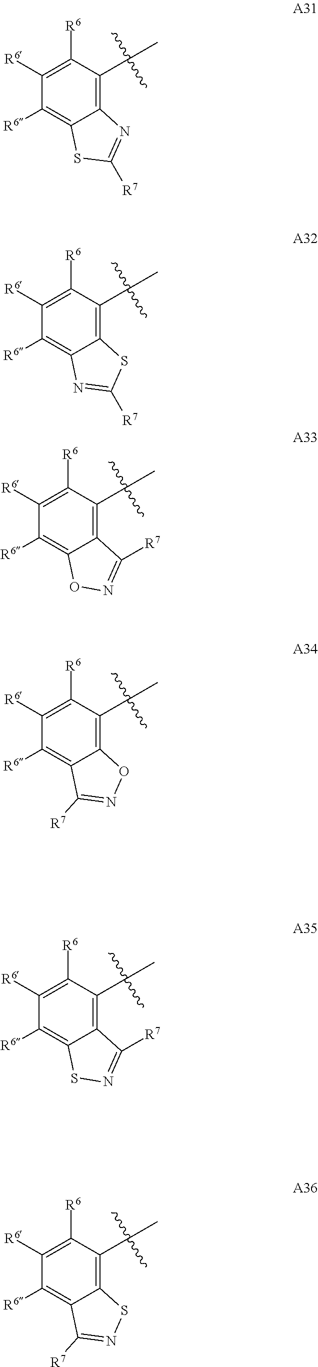
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof.

2. The composition of claim 1, wherein the pyridine carboxylic acid herbicide comprises a compound defined by Formula (II) 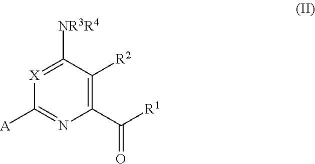
wherein
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof.

3. The composition of claim 2, wherein
R¹ is OR^{1′}, wherein R^{1′} is hydrogen, C₁-C₅ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

4. The composition of claim 1, wherein the pyridine carboxylic acid herbicide comprises a compound defined by Formula (III): 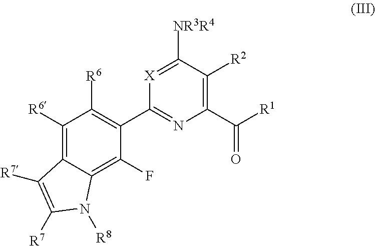
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof.

5. The composition of claim 1, wherein the pyridine carboxylic acid herbicide comprises one of the following:

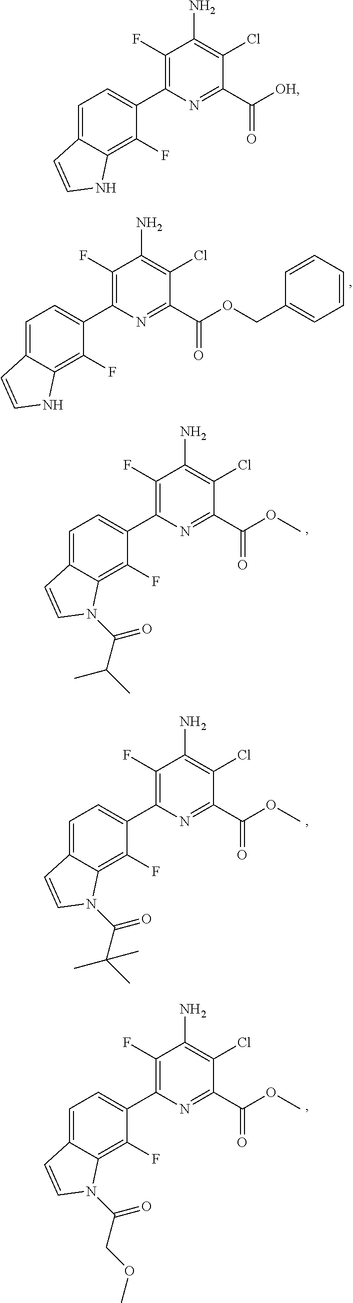 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl ; COCC(=O)n1ccc2ccc(-c3nc(C(=O)OC)c(Cl)c(N)c3F)c(F)c21]

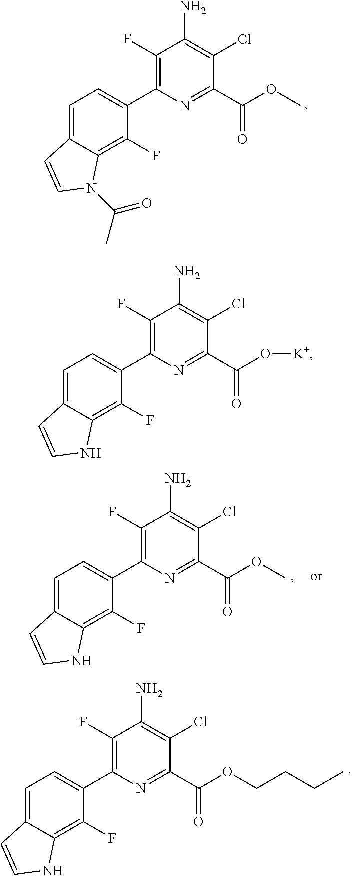

6. The composition of claim 1, wherein the pyridine carboxylic acid herbicide comprises

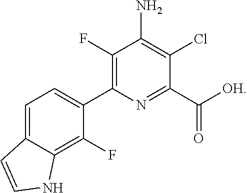 [SMILES: Nc1c(F)c(-c2ccc3cc[nH]c3c2F)nc(C(=O)O)c1Cl]

7. The composition of claim 1, wherein (b) is a phytoene desaturase inhibitor herbicide.

8. The composition of claim 7, wherein the phytoene desaturase inhibitor herbicide is selected from the group consisting of diflufenican, picolinafen, flurtamone, and combinations thereof.

9. The composition of claim 8, wherein the weight ratio of (a) to (b) is within the range from about 1:9000 to about 2:1.

10. The composition of claim 9, wherein the weight ratio of (a) to (b) is within the range from about 1:750 to about 2:1.

11. The composition of claim 10, wherein the weight ratio of (a) to (b) is within the range from about 1:36 to about 1:2.5.

12. The composition of claim 1, wherein (b) is a very long chain fatty acid synthesis inhibitor herbicide.

13. The composition of claim 12, wherein the very long chain fatty acid synthesis inhibitor herbicide is selected from the group consisting of flufenacet, pyroxasulfone, and combinations thereof.

14. The composition of claim 13, wherein the weight ratio of (a) to (b) is within the range from about 1:14000 to about 1.5:1.

15. The composition of claim 14, wherein the weight ratio of (a) to (b) is within the range from about 1:1800 to about 1.5:1.

16. The composition of claim 15, wherein the weight ratio of (a) to (b) is within the range from about 1:20 to about 1:6.

17. The composition of claim 1, wherein (b) is a phytoene desaturase inhibitor herbicide, a very long chain fatty acid synthesis inhibitor herbicide, and combinations thereof.

18. The composition of claim 17, wherein (b) is selected from the group consisting of diflufenican, flurtamone, flufenacet, and combinations thereof.

19. The composition of claim 18, wherein the weight ratio of (a) to (b) is within the range from about 1:14000 to about 2:1.

20. The composition of claim 19, wherein the weight ratio of (a) to (b) is within the range from about 1:1800 to about 1:5.

21. The composition of claim 20, wherein the weight ratio of (a) to (b) is within the range from about 1:20 to about 1:40.

22. The composition of claim 1, further comprising an agriculturally acceptable adjuvant or carrier.

23. The composition of claim 1, further comprising an additional pesticide.

24. The composition of claim 1, wherein the active ingredients in the composition consist of (a) and (b).

25. The composition of claim 1, wherein the composition is provided as a herbicidal concentrate.

26. A method of controlling undesirable vegetation comprising applying to vegetation or an area adjacent the vegetation or applying to soil or water to control the emergence or growth of vegetation a herbicidally effective amount of:
(a) a pyridine carboxylic acid herbicide comprising a compound defined by Formula (I) 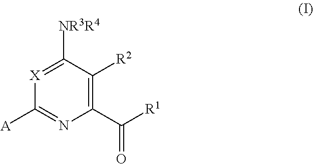
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰ and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 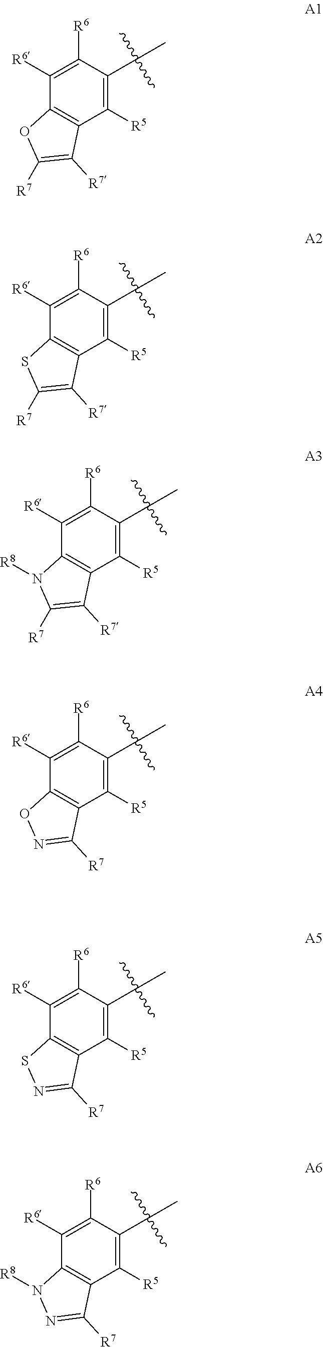 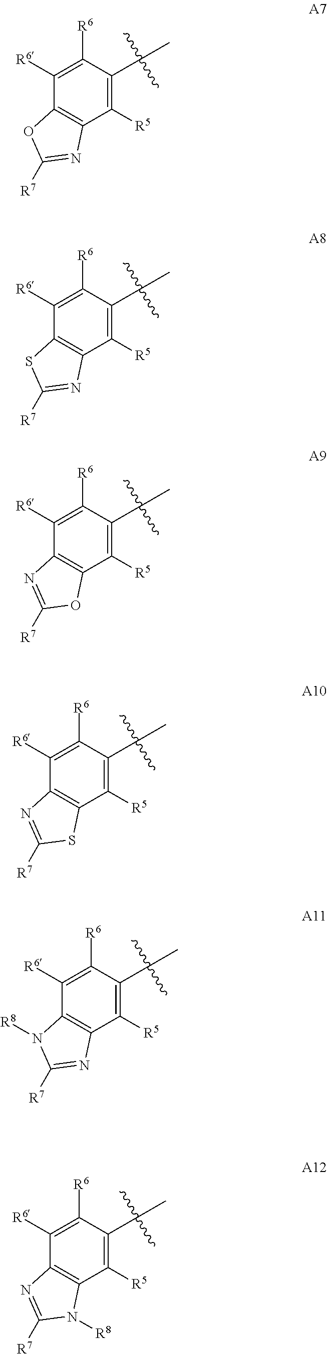 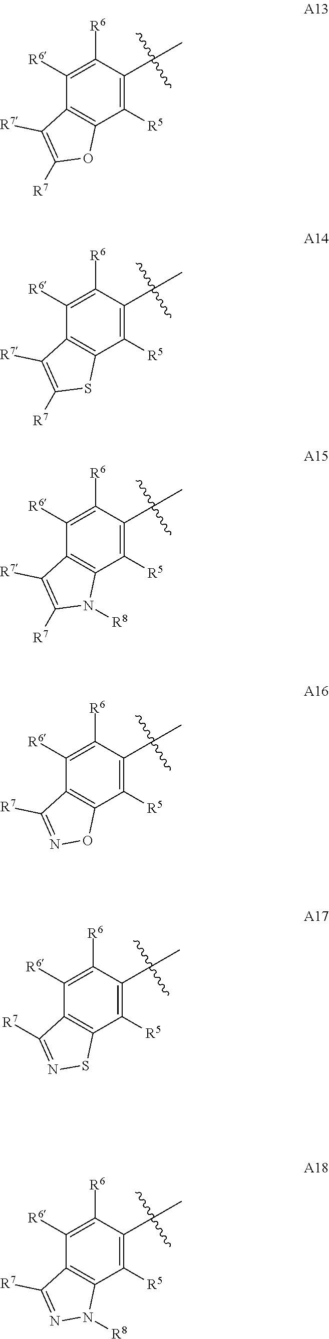 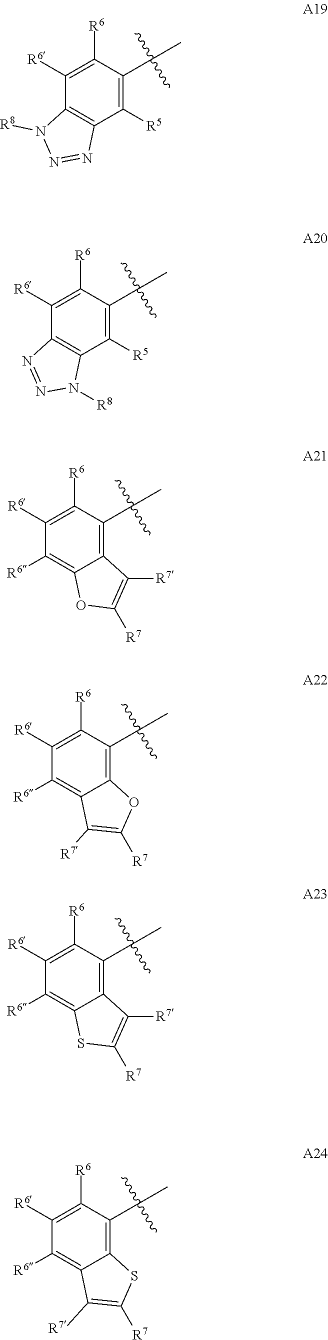 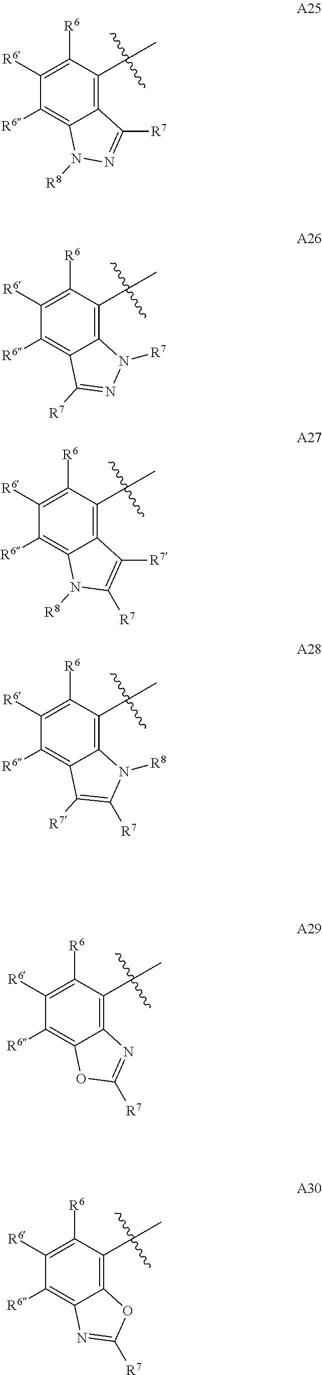 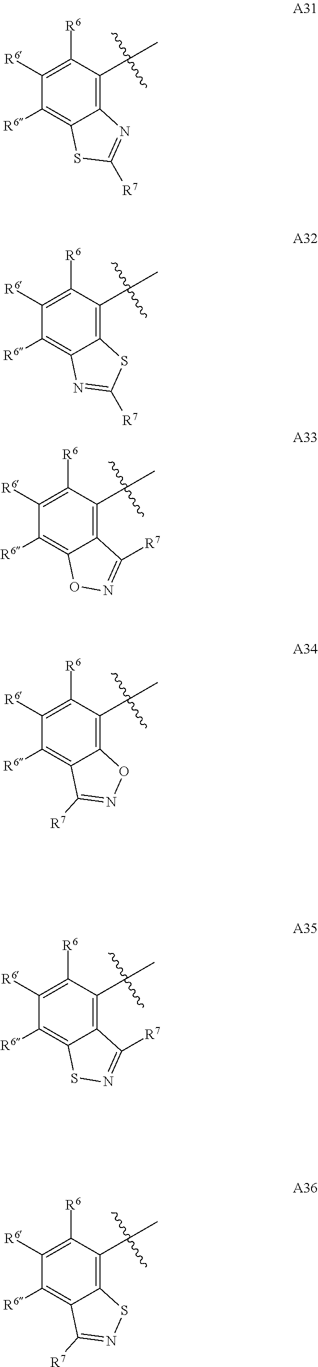
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof; and
(b) a phytoene desaturase (PDS) inhibitor, a very long chain fatty acid (VLCFA) synthesis inhibitor, or a mixture thereof.

27. The method of claim 26, wherein the pyridine carboxylic acid herbicide comprises a compound defined by Formula (II) 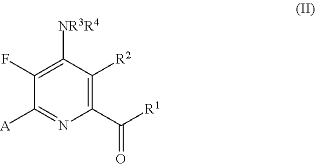
wherein
R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl; R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof.

28. The method of claim 27, wherein
R¹ is OR^{1′}, wherein R^{1′} is hydrogen, C₁-C₈ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

29. The method of claim 26, wherein the pyridine carboxylic acid herbicide comprises a compound defined by Formula (III): 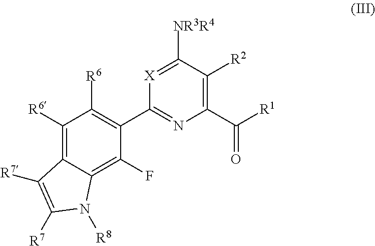
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₅ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide, salt, or ester thereof.

30. The method of claim 26, wherein the pyridine carboxylic acid herbicide comprises one of the following:

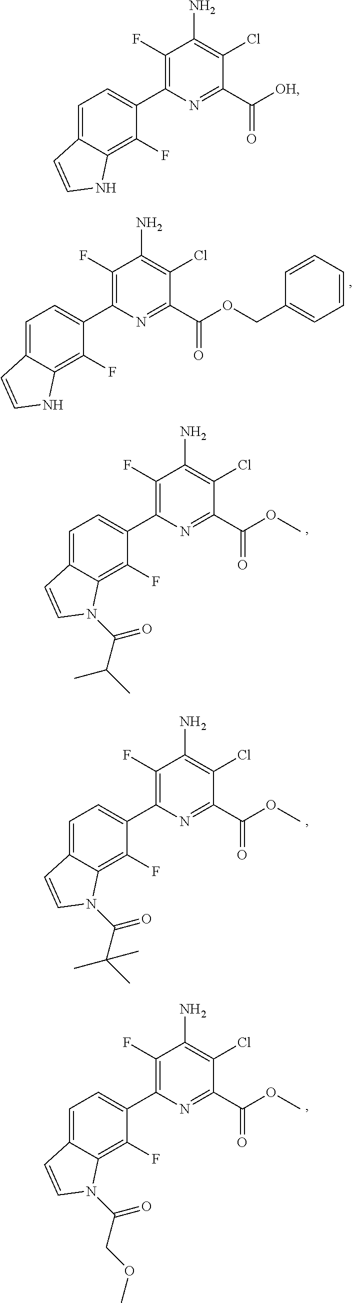 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl ; COCC(=O)n1ccc2ccc(-c3nc(C(=O)OC)c(Cl)c(N)c3F)c(F)c21]

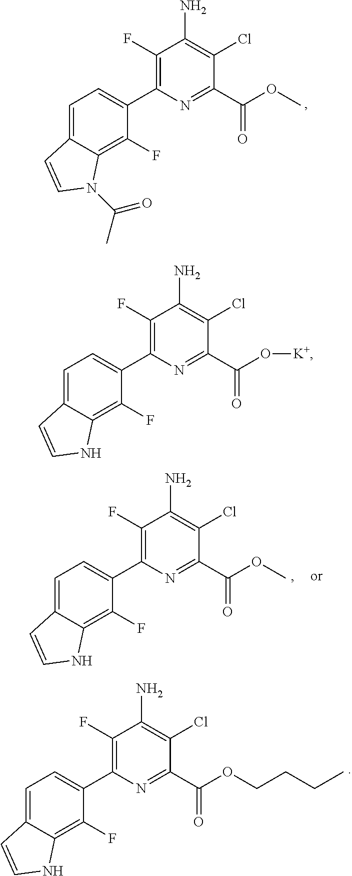

31. The method of claim 26, wherein the pyridine carboxylic acid herbicide comprises

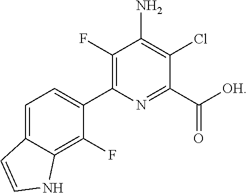 [SMILES: Nc1c(F)c(-c2ccc3cc[nH]c3c2F)nc(C(=O)O)c1Cl]

32. The method of claim 26, wherein (b) is a phytoene desaturase inhibitor herbicide.

33. The method of claim 32, wherein the phytoene desaturase inhibitor herbicide is selected from the group consisting of diflufenican, picolinafen, flurtamone, and combinations thereof.

34. The method of claim 33, wherein the weight ratio of (a) to (b) is within the range from about 1:9000 to about 2:1.

35. The method of claim 34, wherein the weight ratio of (a) to (b) is within the range from about 1:750 to about 2:1.

36. The method of claim 35, wherein the weight ratio of (a) to (b) is within the range from about 1:36 to about 1:2.5.

37. The method of claim 26, wherein (b) is a very long chain fatty acid synthesis inhibitor herbicide.

38. The method of claim 37, wherein the very long chain fatty acid synthesis inhibitor herbicide is selected from the group consisting of flufenacet, pyroxasulfone, and combinations thereof.

39. The method of claim 38, wherein the weight ratio of (a) to (b) is within the range from about 1:14000 to about 1.5:1.

40. The method of claim 39, wherein the weight ratio of (a) to (b) is within the range from about 1:1800 to about 1.5:1.

41. The method of claim 40, wherein the weight ratio of (a) to (b) is within the range from about 1:20 to about 1:6.

42. The method of claim 26, wherein (b) is a phytoene desaturase inhibitor herbicide, a very long chain fatty acid synthesis inhibitor herbicide, and combinations thereof.

43. The method of claim 42, wherein (b) is selected from the group consisting of diflufenican, flurtamone, flufenacet, and combinations thereof.

44. The method of claim 43, wherein the weight ratio of (a) to (b) is within the range from about 1:14000 to about 2:1.

45. The method of claim 44, wherein the weight ratio of (a) to (b) is within the range from about 1:1800 to about 1:5.

46. The method of claim 45, wherein the weight ratio of (a) to (b) is within the range from about 1:20 to about 1:40.

47. The method of claim 26, wherein (a) is applied in amount of from 0.5 g ae/ha to 50 g ae/ha.

48. The method of claim 47, wherein (a) is applied in amount of from 5 g ae/ha to 40 g ae/ha.

49. The method of claim 26, wherein (b) is applied in amount of from 33 g ai/ha to 6720 g ai/ha.

50. The method of claim 26, wherein (b) is applied in amount of from 12.5 g ai/ha to 180 g ai/ha.

51. The method of claim 26, wherein (a) and (b) are applied simultaneously.

52. The method of claim 26, wherein (a) and (b) are applied post-emergence to the undesirable vegetation.

53. The method of claim 26, further comprising applying an agriculturally acceptable adjuvant or carrier.

54. The method of claim 26, further comprising applying an additional pesticide.

55. The method of claim 26, wherein the undesirable vegetation is controlled in a glyphosate-, glufosinate-, dicamba-, phenoxy auxin-, pyridyloxy auxin-, aryloxyphenoxypropionate-, acetyl CoA carboxylase (ACCase) inhibitor-, imidazolinone-, 4-hydroxyphenyl-pyruvate dioxygenase (HPPD) inhibitor-, protoporphyrinogen oxidase (PPO) inhibitor-, triazine-, or bromoxynil-tolerant crop.

56. The method of claim 55, wherein the tolerant crop possesses multiple or stacked traits conferring tolerance to multiple herbicides or multiple modes of action

57. The method of claim 26, wherein the undesirable vegetation includes a broadleaf weed.

58. The method of claim 26, wherein the undesirable vegetation comprises a herbicide resistant or tolerant weed.

59. The method of claim 58, wherein the resistant or tolerant weed is a biotype with resistance or tolerance to multiple herbicides, multiple chemical classes, or multiple herbicide modes-of-action.

60. The method of claim 58, wherein the resistant or tolerant weed is a biotype resistant or tolerant to photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

61. The method of claim 26, wherein the undesirable vegetation includes velvetleaf, blackgrass, pigweed, wild oat, brown mustard, rutabaga, spring rape, winter rape, turnip, lambsquarters, thistle, nutsedge, large crabgrass, barnyardgrass, poinsettia, soybean, sunflower, ivyleaf morningglory, ivyleaf speedwell, kochia, wild buckwheat, giant foxtail, sorghum, common chickweed, wild pansy, or a combination thereof.

62. The method of claim 26, wherein the active ingredients applied to the vegetation or an area adjacent the vegetation or applied to soil or water to control the emergence or growth of vegetation consist of (a) and (b).
